(19) United States
(12) Patent Application Publication
(10) Pub. No.: US 2026/0142554 A1
(43) Pub. Date: May 21, 2026

(54) Operational Systems and Methods for Series Generative AC Devices

(71) Applicant: Icarian Systems, LLC, Fort Collins, CO (US)

(72) Inventor: Eric Seymour, Fort Collins, CO (US)

(21) Appl. No.: 19/449,224

(22) Filed: Jan. 14, 2026

Related U.S. Application Data
(63) Continuation of application No. PCT/US24/38428, filed on Jul. 17, 2024.
(60) Provisional application No. 63/527,387, filed on Jul. 18, 2023.

(51) Int. Cl. H02M 1/00; H02J 3/38; H02J 101/24; H02M 1/12; H02M 1/36; H02M 7/5387

(52) U.S. Cl. CPC H02M 1/0077; H02J 3/381; H02M 1/0016; H02M 1/126; H02M 1/36; H02M 7/53871; H02J 2101/24

(57) ABSTRACT

A system, method and apparatus are disclosed for converting DC power to AC power. The system may include a plurality of series generative AC devices 502 such as DC to AC inverter systems 600 connected in series whose collective output may export power to a AC electrical power delivery network such as a provided AC grid phase. The system may also include an analog reference signal 518 representing the phase voltage used by each of the plurality of series-connected inverters to control proper synthesis of inverter output power. The system may also include a severance device 510 that separates the string of inverters 506 from the grid when not exporting power.

### FIELD

This relates generally to apparatus and methods for converting solar energy to electrical energy, and more specifically to apparatus and methods for more efficient and/or effective conversion of solar energy to electrical energy.

### BACKGROUND

The conversion of light energy to electrical energy using photovoltaics (PV) has become common in residential, commercial, and utility application spaces. Although technology incorporated into PV systems is continuously improving in terms of energy efficiency and economic effectiveness, regulatory advances in recent years often require that, as compared to older systems, additional devices be placed in PV systems. This significant increase in complexity has the potential to slow this historical trend of ever-improving cost effectiveness and energy efficiency, thereby leading to the need for newer, more effective solutions.

Electrical energy created by photovoltaic source(s) requires conversion from DC to AC should it be exported to a utility or stand-alone AC system. These devices, or DC-AC inverters, may be available in a variety of sizes ranging from those small enough to connect to a single photovoltaic module to those capable of processing the power from thousands of modules. Typically, inverters connect to the AC grid with a parallel, or shunt, connection as is done with other grid-connected devices. Parallel grid connections provide constant voltage to the connected device and offer nearly complete independence between connected devices.

The application of conventional parallel-connected inverters to modern, regulatory-constrained rooftop PV installations has led to a variety of available solutions. However, present solutions may require either the use of DC power management components, located proximate to the PV modules, in addition to the inverter or the use of very small parallel-connected inverters (microinverters) suitable for connection to one or several photovoltaic panels (modules). Either approach is less efficient and/or less economical than the arrangement seen in earlier rooftop installations, and still seen in large ground mount installations, of an array of un-augmented PV modules connected to a single inverter as seen in the prior art as depicted in FIG. 1. It is for this reason that alternative designs and methods for photovoltaic power transfer may be sought for rooftop installations.

### SUMMARY

A different type of inverter is proposed here where the AC outputs of a plurality of inverters may be connected in a string. The resulting system may be described as a series-configured connection system through which a plurality of devices may be connected in a string. The number of inverters connected in series is guided by the AC system voltage for a given installation. Each series-connected DC-AC inverter has a DC power source (photovoltaic module(s), battery, etc.) connected at its DC input.

Placing generative devices in series creates considerable challenges to the effective control of such a system. Previous depictions of series generative AC devices, of which series-connected DC-AC inverters are an example, have often been conceptual and lacking in sufficient detail necessary to realize an operable design. Of the previous descriptions that do show how one may enable such a plurality of sources, proposed solutions center on the distribution of time-critical digital signals throughout the system as can be seen in US 2012/0091817 A1 (Seymour, Apr. 19, 2012) and US 2014/0169053 A1 (Ilic, Jun. 19, 2014). This has been perceived as unreliable and/or impractical, likely preventing the adoption of series-connected inverters. Thus, from one perspective, embodiments of the present invention may be characterized as inverters connected in series that provide a series-additive composite AC voltage output through which power may be supplied without reliance on distributed time-critical digital signals.

What is proposed is a plurality of series generative AC devices that instead of using externally provided switching or synchronization control signals conveyed by means of a digital communications path, may use an analog reference of the grid voltage itself. It is noted that the term generative is defined here as a combination of two vernacular definitions: the first being “relating to or capable of production” as in capable of producing an AC output voltage (with or without any associated current or power, with or without any connection to an AC power system), and the second being capable of exporting electrical power. In one embodiment the analog reference may be created by applying the grid voltage across a series-connected voltage divider configured input line where a plurality of voltage divider impedance elements may each be associated with or internal to a series-connected DC-AC inverter. This approach can include installing a dedicated wire in addition to the wire used for export of power. Previously proposed series-connected DC-AC inverters used a single wire for both power and communication. This represents a nearly optimal use of the conductor. This is not only because of its dual functionality of carrying both power and data, but also in that the conductor may be fully utilized with respect to its current-carrying capacity across the full length of the string. By contrast, the electrical distribution wiring used to collect power from multiple parallel-connected inverters does not have uniform current across its length, leading to a much poorer utilization of the overall amount of installed conductor. While uniform conductor current utilization may be retained by the series-connected DC-AC inverter system proposed here, the objective of using merely a single conductor for power and data as presented in the prior art is not. The prior art places emphasis on single-wire design to such an extent as to teach away from what is being proposed here.

A proposed embodiment contains a control system that takes the information provided by the analog high-resolution AC electrical power delivery network voltage input and may use it for purposes of grid synchronization, power regulation and output current shaping. Unlike centrally directed control methods, a proposed embodiment may implement a controller that exhibits a non-coordinated collective action that allows a plurality of non-centrally directed controlled, series-connected AC generative devices to, while outputting identical AC current, match an externally defined AC voltage comprised of a respective plurality of heterogeneous time-varying, or dynamic, inverter output voltages without requiring the inverters to communicate with each other. Thus, a characterization of an embodiment can be that of having a system of series-connected DC-AC inverters that provide a collective output that is a composite of a plurality of heterogeneous time-varying outputs or signals. A possible additional embodiment can also be based on a characterization of AC series-connected sources exhibiting non-coordinated collective action.

Other embodiments may include a collectively managed device interlock perhaps with a system connection device that may take certain components often found within inverter systems, such as contactors and fuses, and place them at the end of the string(s) to avoid the cost, size, and redundancy of placing them within the inverters.

### BRIEF DESCRIPTION OF THE DRAWINGS

Various objects and advantages and a more complete understanding of the present embodiments are apparent and more readily appreciated by reference to the following Detailed Descriptions when taken in conjunction with the accompanying Drawings where like or similar elements are designated with identical reference numerals throughout the several views and wherein:

FIG. 1 is a diagram depicting series-connected photovoltaic modules connected at their respective DC outputs as is known in the prior art;

FIG. 2 is a diagram depicting series-connected photovoltaic modules with distributed severance switches as is known in the prior art;

FIG. 3 is a diagram depicting series-connected DC-DC photovoltaic optimizers connected in a DC series string whose collective output is connected to an inverter as is known in the prior art;

FIG. 4 is a diagram depicting a plurality of parallel-connected micro-inverters as is known in the prior art;

FIG. 5 is a diagram depicting an exemplary system including series-connected inverters, analog reference and multi-string severance device;

FIG. 6 is a schematic depiction of an exemplary embodiment of an inverter system, which may be utilized to implement the inverters described with reference to FIG. 5;

FIG. 7 is a schematic depiction of an exemplary control component that may be utilized to realize the control component described in FIG. 6;

FIG. 8 is a schematic depiction of an exemplary waveshape correction component that may be utilized to realize the waveshape correction component described in FIG. 7;

FIG. 9A is a schematic depiction of an exemplary interlock component that may be utilized to realize the interlock components described in FIG. 6;

FIG. 9B is a schematic depiction of yet another exemplary interlock component that combines interlock and analog reference components that may be utilized to realize the interlock components described in FIG. 6 and the analog reference components described in FIGS. 5 and 6;

FIG. 10 is a block diagram depicting an exemplary embodiment of the control portion depicted in FIG. 6;

FIG. 11 is a control diagram depicting a synchronous reference frame controller that may be utilized to realize the measurement and control portion described in FIG. 6;

FIG. 12A is a phasor diagram depicting the applied voltage with respect to the power system reference of the various series-connected inverters in a string operating under balanced power conditions;

FIG. 12B is a phasor diagram depicting the applied voltage with respect to the power system reference of the various series-connected inverters in a string operating under unbalanced power conditions;

FIG. 13 is a schematic depiction of an exemplary AC electrical power delivery network voltage measurement input (reference voltage input) component that may be utilized to realize the reference voltage input described in FIG. 6;

FIG. 14 is a schematic depiction of an exemplary output filter assembly that may be utilized to realize the output filter assembly described in FIG. 6;

FIG. 15 is a block diagram depicting an exemplary embodiment of the control portion depicted in FIG. 6;

FIG. 16A is a phasor diagram depicting the measured reference voltage with respect to the power system reference of the various series-connected inverters in a string under non-operating conditions when connected to an energized reference voltage line;

FIG. 16B is a phasor diagram depicting the voltage with respect to the power system reference of the various series-connected inverters internal references whose outputs are connected in a string under non-operating conditions when connected to an energized reference voltage line;

FIG. 17A is a phasor diagram depicting the measured reference voltage with respect to the power system reference of the various series-connected inverters in a string under non-operating conditions when connected to an energized reference voltage line with low admittance paths switched open;

FIG. 17B is a phasor diagram depicting the voltage with respect to the power system reference of the various series-connected inverters internal references whose outputs are connected in a string under non-operating conditions when connected to an energized reference voltage line with low admittance paths switched open;

FIG. 18 is a schematic depiction of an exemplary embodiment of a system connection device, which may be utilized to implement the system connection device described with reference to FIG. 5;

FIG. 19 is a schematic depiction of an exemplary embodiment of a multi-source input auxiliary power source component for a series-connected DC-AC inverter.

### DETAILED DESCRIPTION OF PREFERRED EMBODIMENTS

It should be understood that embodiments include a variety of aspects, which may be combined in different ways. The following descriptions are provided to list elements and describe some of the embodiments of the invention. Elements are listed with initial embodiments; however, it should be understood that they may be combined in any manner and in any number to create additional embodiments. The variously described examples and preferred embodiments should not be construed to limit the embodiments of the invention to only the explicitly described systems, techniques, and applications. The specific embodiment or embodiments shown are examples only. The specification should be understood and is intended as supporting broad claims as well as each embodiment, and even claims where other embodiments may be excluded. Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

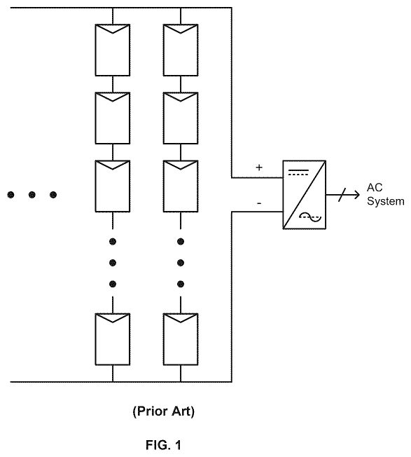

As background, it can be understood that a group of packaged photovoltaic cells can be referred to as a PV module or panel. When installed, such panels may be mounted to racking. In the case of ground-mount racking, such as with large utility-scale installations, the modules may be simply wired in series-connected “strings” which are then “combined” in parallel to form an array as shown in FIG. 1. The resulting combined DC electrical power is often then fed to an inverter for export to the AC system. The inverter controls the power flow to the AC system, perhaps including determining, when appropriate, the maximum possible power extractable from the PV array. The maximum extractable power can be a function of irradiance, which can be time-variant. Therefore, a prominent feature of the power conversion approaches described herein is often the effective extraction of time-variant maximum power from the array. This is known as maximum power point tracking (MPPT).

Photovoltaic systems installed on structures that may be architecturally sophisticated and/or occupied by people are more complicated than those seen in utility applications. The first reason for this is that varied mounting angles and/or shading effects may exist across sections of such PV arrays resulting in a preference or need for a distributed approach for MPPT from such sections. Such distributed MPPT may be applied to each PV panel within the array or applied to multiple-panel sections within the array.

The second reason PV installations on occupied structures can be more complicated than ground-mount systems is the emergence in recent years of regulatory requirements for “rapid shutdown”. This mandates that PV installations on occupied structures be capable of being shut down at their source(s), for the protection of users and emergency personnel. That is, once shutdown, there may be little or no voltage or available energy leaving the vicinity of the PV modules themselves. This can necessitate the presence of some sort of device proximate to the individual PV modules.

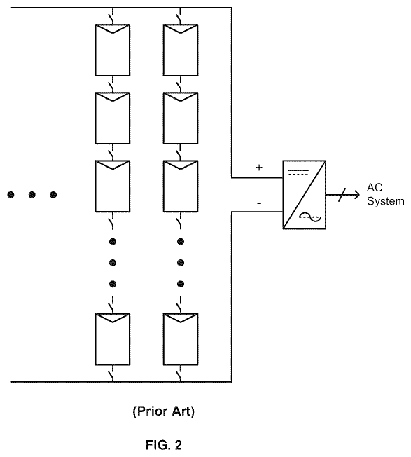

There are several types of power management systems that satisfy the requirements of such PV installations. The first is a conventional inverter, like those used on ground-mount systems, operating in concert with switches distributed throughout the PV array for the purpose of severing and segmenting the array in its shutdown state in a way that complies with regulatory requirements as shown in FIG. 2, albeit without the ability to offer distributed MPPT. Inverters in such cases are often comprised of more than one power-processing “stage”, where a DC-DC converter stage pre-regulates power flow to a subsequent inversion stage (DC-AC). Multi-stage power conversion is a frequently encountered aspect of the various power management solutions described herein.

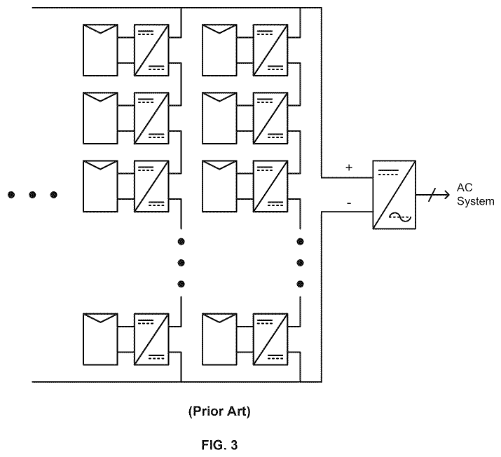

The second type of system for use on such structures consists of distributed DC-DC converters, often called optimizers, co-located with their respective PV modules feeding collected DC power to an inverter as shown in FIG. 3. Such systems also have multiple stages of power conversion, but since the distributed DC-DC converters can turn PV module power off at the source, there may be no need for additional severance/segmentation switches as in the previously described system. The DC-DC optimizers in such systems are frequently connected in series at their outputs, thereby building the higher DC voltages needed for input to the inverter through stringing. Building higher voltage this way allows individual optimizer output voltages to be relatively low and therefore of similar magnitude to their input voltages coming from the PV modules. For this class of power converter, known as a “switch-mode” converter, this condition may be nearly ideal and allows DC-DC optimizers to be small, cost-effective, and energy efficient.

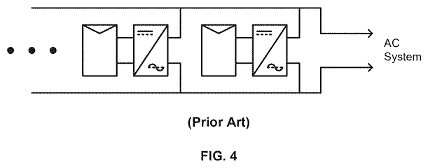

The third type of power conversion system used on architecturally sophisticated and/or occupied structures is the micro-inverter. Micro-inverters are typically connected to one or more PV modules at the DC input. The AC outputs are combined in parallel as shown in FIG. 4. Like DC-DC optimizers, conventional microinverters can perform maximum power point tracking and shutdown functions specific to one or more PV modules. Given that such devices have a set of grid-interactive operational characteristics like larger inverters and may be grid-connected in parallel like larger inverters, the panel-localized shutdown function may be achieved simply by users or emergency personnel turning off the AC power to the system.

Micro-inverters, while conceptually elegant, have several practical drawbacks. The devices, despite being reasonably small, may be more complicated and contain a greater number of power-processing components than DC-DC optimizers. This may be in part due to the nature of the inversion function but may also be due to having to convert a relatively low voltage (˜40 Vdc) from the PV module to a relatively high voltage at the output (typically 240 Vac in the US). Such a voltage disparity does not exist in larger inverters or optimizers and makes it difficult to achieve comparable high efficiency. Greater inefficiency is unattractive in PV systems for energy-export revenue reasons, but also exacerbates an already challenging thermal management problem. Heat rejection may be understandably difficult for any device residing beneath an often very hot PV panel where practical concerns may preclude use of fans or elaborate cooling systems. Worse still, the seemingly simple mitigation of using a finned metal enclosure is somewhat undesirable due to cost and the requirement in electrical systems that de-energized and exposed metal components be connected to a safety ground. As such, plastic enclosures for these devices may be preferred. The poor ability of plastic enclosures to reject heat reinforces the desirability for a microinverter with high conversion efficiency leading to minimal heat loss. Additionally, designs capable of high voltage conversion ratios such as those seen in conventional micro-inverters typically are more expensive than converters whose input and output voltages may be similar in magnitude. Also, conventional microinverters may be subject to the same requirements as larger inverters (i.e., overcurrent protection, electrical isolation requirements, etc.). This apparatus and functionality results in a disadvantageous economy of scale and makes achieving cost-effective designs difficult for conventional microinverters.

It is therefore desirable to devise an operational system that combines the various benefits of each of the previous approaches. Such an inverter design may have the size, cost, and efficiency benefits commonly seen in a DC-DC optimizer due to converting a low DC input voltage (˜40 Vdc) to a low AC output voltage (˜25 Vac). As can be appreciated, this low DC-to-AC conversion ratio, potentially as low as 0.625 or lower, combined with a ratio of AC system voltage to inverter output voltage equal to or greater than 5-to-1, confers cost and performance benefits not seen in present solutions. Such a system would also have the benefits of a conventional microinverter in that there may be no subsequent power conversion stage as is required with DC optimizers, and shutdown of the system requires nothing more complicated than shutting off AC power for the system. Such an inverter would further have the benefit, also shared with DC optimizers and severance devices, of not needing to be tolerant of, or exposed to, high AC system voltages at each device as may be the case with conventional microinverters.

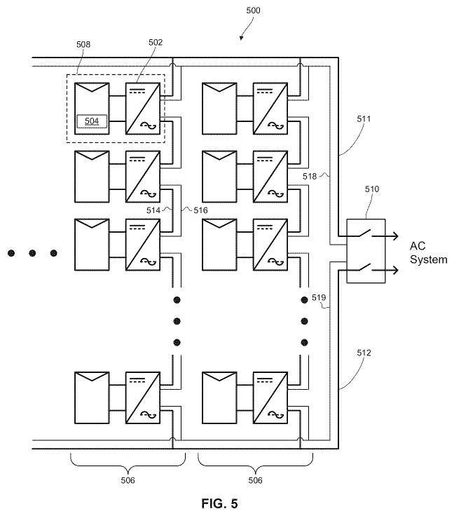

Referring to FIG. 5, shown is an exemplary system 500 that operates according to several embodiments. As shown, in this implementation a plurality of unidirectional or bidirectional DC input sources 504, each connected respectively to a plurality of inverters 502, are connected in series on the AC side of their power outputs 514 thereby establishing a string 506. At least one string may be connected in parallel to the collected outputs 511 and 512. The outputs are then routed through a system connection device 510 to eventual connection to the AC system. The system connection device contains components that may be beneficial and/or required for PV systems such as overcurrent protection, service disconnection switch, automated disconnection relays, and a ground-fault detection/clearance device. It should be noted that the system configuration shown in 500 has both single-phase (shown in FIG. 5) and polyphase variants. As an example, a three-phase variant places at least one 506 element per phase with collected output power connections 511, 512 and reference voltage connections 518, 519 connected to a three-phase variant of system connection device 510.

Control of each inverter, and by extension the system, requires it to have information relating to AC system voltage. Such information is not available locally by means of voltage measurement at the inverter output as is the case for parallel-connected inverters. The reason for this is that, while the AC output voltage (i.e., grid voltage) of a parallel-connected inverter is largely independent of what such an inverter is doing, the output of a series-connected inverter is almost entirely dependent on its operation and the operation of the other inverters in the string. Any attempt to use the output voltage of the inverter to gain information pertaining to the AC system frequency, voltage amplitude, or instantaneous voltage value may create an unstable feedback loop. A previously proposed solution to this problem may be to issue a synchronization signal to the inverter from a centralized device. The signal, often transmitted as a coupled digital pulse(s) on the output line typically conveys information pertaining only to frequency, or period. As there may be no practical way described by prior art to convey instantaneous voltage information, the AC system waveshape must be presumed by the inverter to be perfectly sinusoidal which, in turn, renders such systems susceptible to misbehavior or malfunction when presented with AC system power quality problems where the AC system voltage departs from the sinusoidal ideal. Additionally, since such an approach requires extensive signal processing by a centralized device, followed by what must be an extremely reliable digital signal transmission path, the inverters in such systems may be characterized as being significantly dependent on centralized control. In contrast, the series-connected inverter proposed here may use an analog AC system voltage reference signal. This signal may be the AC system voltage itself, which may be impressed across a voltage divider circuit separate from the AC output comprised of an impedance element within each inverter. As such, the waveform used by the inverter control may be non-sinusoidal, not derived from any other signal, and non-presumed. This approach does not rely on a processed control signal from a centralized device and allows for AC system voltage information to be provided to an inverter at an arbitrarily high resolution. High resolution may be defined as an AC electrical power delivery network voltage input that accurately represents the AC electrical power delivery network voltage at greater than two accurate points of voltage information per AC cycle. Higher resolutions may be possible, including, but not limited to, greater than 15, 30, 100, and 166 sampled accurate points per AC cycle, a substantially continuous sampling rate, or, in the case of an analog controller, an analog input. This characteristic, where the inverter controller does not rely on AC system voltage data that has been previously processed by another device, along with the characteristic that the inverters may be similarly operated and unaware of each other, qualifies the proposed inverter to be uniquely characterized as autonomously self-controlled. More specifically, each inverter may be configured to acquire and process a plurality of control information that may be isolated so that each is not responsive to or aware of the control for any other inverter. Much of this plurality of information may be acquired and processed on a sub-cycle or per-cycle timescale exclusively by control circuitry within an individual inverter.

An embodiment of such an analog reference is shown in FIG. 5 as an AC source line voltage reference string 516, which is electrically, and quite possibly physically, adjacent to power-carrying line 514. The analog reference line and power-carrying line may indeed be contained within the same cable or cord. The line reference conductor carries no relevant current while each inverter 502 presents an identical voltage divider impedance to the analog reference. Therefore, the analog reference provides each inverter with an accurate representation of system voltage which may be subsequently used by the inverter for effective control. A reference string may be connected to the reference distribution lines 518 and 519 which may be connected to, and sourced by, the system connection device. Accordingly, another characterization of an embodiment can be that of a series-connected inverter synchronization signal provided through use of a voltage divider system where each inverter contains a voltage divider impedance which may be connected to a serially connected reference line among the plurality of inverters.

Prior to the proliferation of PV systems, electrical systems comprised of series-connected devices were historically uncommon. This may be due not only to the undesirable effects associated with a failed device on the collective string of devices, but also due to operational instability or inability to effectively share power among devices. This may be true even for a series string of passive, consumptive devices such as incandescent light bulbs. Such difficulty is compounded when one considers the scenario where the devices in question are not merely passive but rather active in nature. Active components or devices may be those that include an amplification element such as a switch that processes greater power on its output than may be required at its actuating input. Other amplification (active) elements may be proportional in nature where a signal may be increased or multiplied in voltage, current, power, and/or other value. The term amplification element, or amplifier, may also be used to describe the behavior of various mathematical functions including but not limited to summing, subtracting, multiplying, and integrating, in either hardware or software. Active devices comprised of at least one active element may exhibit either consumptive or generative behavior. The difficulty of applying active devices in series-connected strings may be compounded even further when such series-connected devices are processing alternating voltage and current as opposed to direct voltage and current as described in DC optimizers. As such, the control of series-connected inverters may be dramatically more difficult than control of any of the previously mentioned power conversion systems.

One reason for the difficulty of controlling this device/system (even after an analog reference of AC system voltage is provided to each inverter) is that the normal relationships for power flow into an AC system do not apply. Every conventional, parallel connected inverter depicted in FIGS. 1-4 contains one or more AC-side inductors that serve two purposes: firstly, to help filter the high frequency switching components created by the inverter which limits the amount of high frequency noise exported to the AC system, and secondly to create a reactance across which the fundamental frequency component of the inversion voltage (i.e., 60 Hz in the US) interacts with the AC system voltage. In general, if the inversion voltage leads the AC system voltage in phase, the result is the export of real power. Were the inverter to create a lagging voltage, the result would be the consumption of real power. Additionally, if the inverter creates a voltage in-phase but greater in magnitude than the AC system voltage the result is the export of reactive power, with a lower magnitude voltage resulting in consumption of reactive power. These relationships are essential to the design of controllers for parallel-connected inverters, regardless of size or whether the AC system is single-phase or polyphase. However, for series-connected inverters these relationships may not be at all helpful in the design of a device controller. For instance, should a single device in a series string attempt to increase its export power by further leading in phase its inversion voltage with respect to grid voltage the result would not be an increase in power but would more likely compromise the collective stability of all inverters in the string. For this reason, successful operation of series-connected inverters requires other methods to be developed.

What is proposed here is a series-connected inverter employing autonomous control, local to the device itself, to achieve a non-coordinated collective action among a plurality of series-connected devices where output voltage of the devices is continuously reapportioned within the string. Thus, a characterization of an embodiment can be that of series-connected inverters with autonomous control. The device may be comprised of multiple controls using multiple locally measured individual high-resolution real-time data inputs pertaining to device output power and AC electrical power delivery network voltage. Naturally, such autonomous control can be non-coordinated and yet can provide a meaningful collective action. The result of this non-coordinated collective action may be the summation of heterogenous voltages of the different devices in the series string that match the applied AC electrical power delivery network voltage. Another result of the non-coordinated collective action may be the creation of the string alternating current, under which all devices must instantaneously operate irrespective of differences in power level. From a system perspective, an operational system for series generative AC devices contains a plurality of generative AC device controls each contained within a respective plurality of similarly phased autonomous series generative AC devices, each responsive to its respective control.

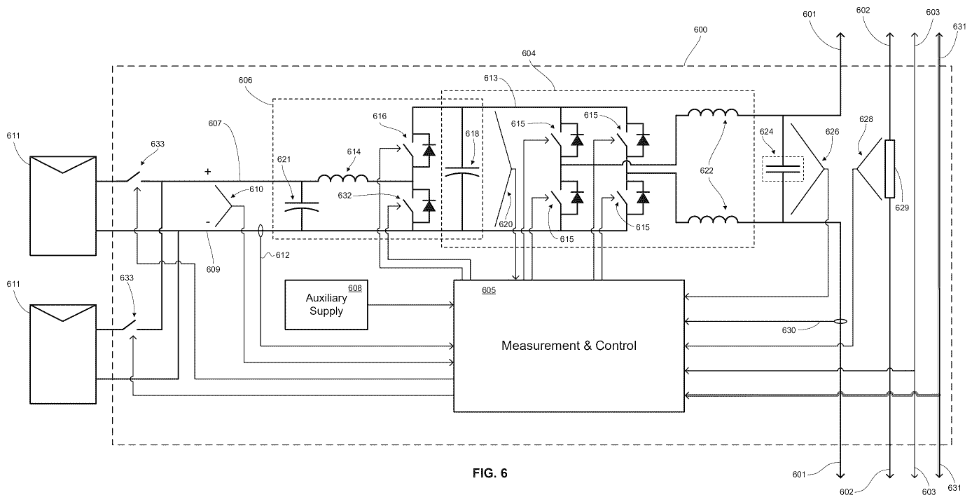

As shown in FIG. 6, an exemplary embodiment of a series-connected inverter system 600 used in the system shown in FIG. 5 as element 502. The inverter system is connected to at least one source of DC power 611, which may be a PV module or other DC source, which is connected to a DC-side which may include a DC switch 633 to disconnect DC source power delivery to the inverter, and measurements for voltage and current. The switch shown is further connected to the DC inputs, 607 and 609 respectively, that power the DC-DC converter 606. The input voltage is measured and reported to the controller 605 with voltage measurement device 610. Input current is measured and reported to the controller with current measurement device 612. The exemplary embodiment contains a DC-DC converter as a means for providing a smooth flow of power from the DC source, as may be required for PV modules. This can be especially important as the subsequent inverter 604 necessarily processes power in a pulsation at twice the power system frequency due to the single-phase nature of the device. The difference in power characteristics between the DC-DC converter and the inverter may be accommodated through use of a bus capacitor assembly 618. The DC-DC converter consists of an input filter capacitor 621, an inductor 614, a controlled boost switch 632, a boost diode 616, and capacitor assembly. The boost diode of switch 616 may be implemented as a transistor body diode or other anti-parallel diode as shown. This allows for a reduced loss condition when using the DC-DC converter as described but also allows for bidirectional operation should such a system be used with a bidirectional DC source. Voltage on the bus 613 is measured with voltage measuring device 620 and provided to the controller. The inverter may share the bus capacitor assembly with the DC-DC converter and is comprised of controlled switches 615 and ac-side inductors 622. Filtering of high frequency switching currents is done by inductors 622 and the shunt capacitor assembly 624. The inverter may be configured for unidirectional or bidirectional operation. The AC-side is comprised of the shunt capacitor assembly, AC output voltage measurement device 626, AC line current measurement device 630, and the generative AC output 601. Output voltage between series connections is measured with the AC output voltage measurement device and provided to the controller. Line current is measured with the AC line current measurement device and provided to the controller. The line voltage reference is connected to the inverter using series connections 602 and is measured across impedance element 629 using reference voltage measurement device 628 and provided to the controller. An interlock may be provided to the controller using the multi-node interlock string 603. The auxiliary power supply 608, which provides internal power for the inverter, may be sourced from the DC input 607, the DC bus 613, the AC reference voltage 628, the series generative AC output 601, or some combination. An embodiment may include at least one communication line 631 that facilitates communication between the plurality of inverters and the system connection device to effect control of at least some activity of the inverters. The communication line may be serially connected to each of the inverters.

The DC-DC converter 606 serves to both raise voltage as measured between the positive input 607 and the negative input 609, to the DC bus 613 and to provide a uniform power flow from the DC input source 611. Power flow in single-phase devices inherently follows a sine-wave pulsation at a frequency that is double the system frequency. Conversely, the DC input source, particularly when it is a PV module, typically requires a smooth, non-pulsating flow of power. Therefore, voltage on the shared DC bus 613 is expected to contain a ripple component, which further compounds the difficulty of effectively controlling the inverter. The bus capacitor assembly 618 functions to both absorb differences in instantaneous power flow between the DC-DC converter and the inverter as well as absorb switching frequency current ripple for both the DC-DC converter and the inverter. As such, the bus capacitor assembly 618 may be comprised of a variety of capacitors selected for low and high frequency performance across a wide variety of capacitances using different capacitor technologies.

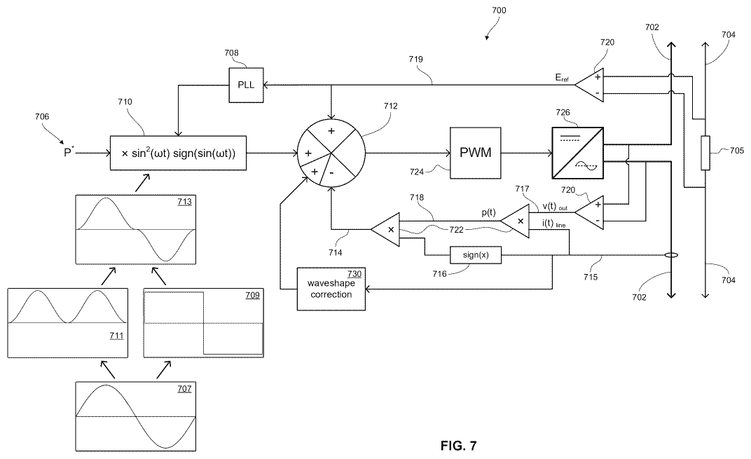

Referring next to FIG. 7 it is a control diagram of an exemplary embodiment of control portion 700 that may be used to implement inner-loop aspects of control portion 605 depicted in FIG. 6 (where inner-loop refers to the fastest layer of control which is connected to the modulator directing the inverter). As shown in the embodiment, the proportioned analog line reference voltage 719 is measured across impedance element 705 using differential analog measurement device 720. Thus, a characterization of embodiments can be that of series-connected inverters that may use a proportioned analog reference to control outputs. The analog line reference voltage can be used to create a feed-forward signal in the summing amplifier 712. This feed-forward signal allows for the creation of something of a “base-state” output of the inverter. And accordingly, another characterization of an embodiment can be that of series-connected inverters that include a feed forward type of control element. This base state may be understood to be an inverter output voltage, that when combined with the other devices in the series string, approximately matches imposed AC system voltage in a way that does not result in any current. For this, a characterization of an embodiment can be that of providing series-connected inverters that include a control signal that approximately matches a desired AC signal. Further, the controller may continually compensate the gain of the feed-forward signal for variable DC bus voltage as a means of effectively providing a reasonably accurate base state. Subsequent regulation of another setpoint/feedback parameter(s) may adhere to or depart from the base state as desired to allow flow of current and power. Depending on the degree of ripple in the DC bus, the feed forward signal may be correctively compensated for such ripple. The summing amplifier 712 may be implemented using either analog or digital methods. The analog line reference may be further used by phase-locked-loop (PLL) 708. The PLL output, in the form of a trigonometric angle available at any moment in time can be used in the power flow synthesis portion 710.

The control approach employed for use in conventional, parallel-connected inverters, where desired average power and reactive power are achieved by inner-loop regulation and synthesis of generative AC output current of proper magnitude and phase (with respect to AC system voltage) can be contrasted to the proposed control approach used in the series-connected inverter. In the series-connected inverter, any attempt to directly regulate current would cause said inverter to conflict with the others attempting to do the same. Of course, the current must be non-zero for any of them to deliver power, but it must be created collectively-preferably by individual devices that are unaware that they are part of a collective. However, to achieve this, control must be performed on an electrical parameter other than output current itself. Another likely electrical parameter may be output voltage. Unlike output current, output voltage does not need to be identical among devices in the string. However, this too presents a problem as the sum of output voltages is not a discretionary quantity but rather a constraint imposed by the AC system. The effective use of voltage regulation for this purpose would likely require fully centralized, high-speed, digital control of all devices in a string from some controlling device in possession of all real-time electrical parameters in the system. Again, such an approach is highly undesirable. Another electrical parameter that may be a candidate for inner loop regulation of the device is power. What is proposed is use of a real-time value of power within the inner loop itself. However, this creates yet another problem in that real-time power in a single-phase device delivering only real power takes the form of a sine-squared wave which, as a mathematical function, is twice the AC system frequency and does not go below zero value, which is not useful in the control of a device that must create and operate with AC quantities.

A possible solution to this problem is to introduce an alternating product to the sine-squared function thereby allowing it to be used in regulation of the device's alternating output. Thus, yet another characterization of an embodiment can be that of a series-connected inverter system including a real-time power element, and for some embodiments a sine-squared function for control of the system. This is shown in FIG. 7 where sinewave 707 is multiplied with itself to form sine-squared function 711. Additionally, the sign of the sinewave 707 is computed to form waveform 709. Further, 711 and 709 may be multiplied to create alternatively signed sine-squared waveform 713. This method, as applied to the inner-loop setpoint, requires a setpoint amplitude to be multiplied with waveshape 713, which is then passed to the inner-loop amplifier. Effective regulation of real-time power, which includes synthesis of a real-time setpoint combined with a similarly constructed feedback within the inner loop, thereby allows each individual device simultaneously to regulate power without direct control of either current or voltage. The plurality of inverters, to satisfy their individual power delivery objectives, collectively create a non-zero output current while continually re-apportioning each inverter's own share of line voltage. In this way, they create a shared identical current and individual output voltages, that while potentially heterogenous, sum to the imposed AC system voltage at all moments in time. Furthermore, effective realization of real-time power control contributes to the objective of non-coordinated collective action among a plurality of series-connected inverters.

The average power setpoint 706 may be calculated to match power flow from the DC-DC converter while maintaining desired average DC bus voltage 620 using outer-loop control feedback. More specifically, the average power setpoint value may be predominantly set by the controller to be equal to the power flowing into the DC-DC converter. This intended match of power, no matter how good, may not be perfect. As a result, the bus voltage may drift up or down. By measuring the bus voltage and controlling it with an outer regulation loop, slight adjustments may be made to the average power setpoint 706 that stabilizes the average bus voltage at a desired level. The average power setpoint is then passed to the power flow synthesis portion. The power flow synthesis portion creates a scaled, periodically signed, sine-squared function that is then passed as a real-time power setpoint input to the amplifier 712.

In this embodiment, the filtered inverter output voltage is measured using differential measurement device 720 to create the output voltage measurement 717. The real-time line current 715 is measured and multiplied with the inversion stage output voltage measurement using a multiplier 722 to create the real-time output power measurement 718. The line current measurement is also input to a sign function 716 whose output is multiplied with real-time output power measurement to create a real-time, periodically signed, output power measurement. This real-time, periodically signed, output power measurement is then passed as feedback to the amplifier 712. The output of the amplifier is passed to the pulse-width modulator (PWM) which controls the semiconductor switches in the inverter 726. The combination of the line reference feed-forward and the real-time, periodically signed, output power feedback control can enable each inverter to be simultaneous autonomous (operate without centralized control) and to collectively allow the plurality of inverters comprising each string to independently process heterogenous power levels while simultaneously processing a common, identical current with associated heterogenous voltage outputs that add to an externally determined, and imposed, voltage sum. The exemplary embodiment may therefore be characterized as a system comprising a plurality of devices, providing non-coordinated control of each such device, thereby creating a collective action that creates a common, uncoordinated yet collectively managed current and individual, time-varying, heterogenous output signal such as a voltage.

In some exemplary embodiments, the controller portion 700 relies on feed-forward and feedback information that may be both dependent on an alternating voltage. A difficulty with this approach may be that the controller exerts little influence over proper output current near voltage zero crossings. This is since both the voltage feed-forward and real-time power regulation are zero irrespective of current value near voltage zero crossings. The result may be a distorted current waveform that departs from the sinusoidal ideal. To correct this, a current waveshape correction portion 730 can be included whose output is input to the amplifier. The characterization of such an embodiment may be claimed as a system of series-connected elements with a control that prevents and/or corrects waveshape distortion caused by moments of low-gain behavior.

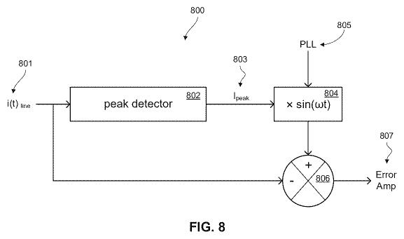

Referring to FIG. 8, it is a waveshape correction portion 800 that may be used to implement waveshape correction portion 730 in FIG. 7. In the exemplary embodiment, the real-time inverter output current measurement 801 is input to peak detector 802. The peak value 803 is then used to synthesize an ideal, and scaled, sine signal 804. Thus, a characterization of an embodiment can be that of a system with a plurality of inverters or other devices that may use a peak value to control, or even synthesize, outputs from such devices. The real-time inverter output current measurement may be then subtracted from this ideal, scaled signal in amplifier 806. The output of the amplifier 806 is then sent to the input of the controller amplifier. The amplifier 806 may be set to a gain appropriate to minimize any potential output current distortion. This counterintuitive approach, where a signal is quantitatively measured, artificially replicated, and then subtracted from itself, while appearing to be of little consequence, is a way to provide waveshape correction at moments in time where the primary method of control may be at low gain and could otherwise allow signal distortion.

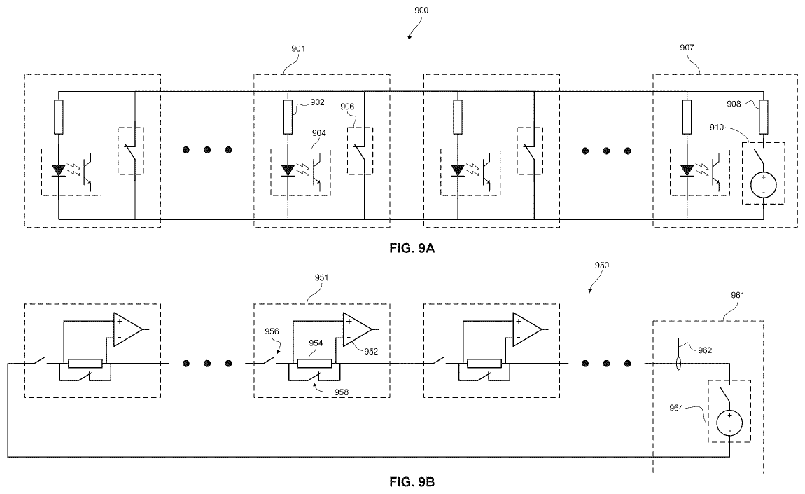

Referring next to FIGS. 9A and 9B, shown are different embodiments of the interlock that may be used to implement the interlock 603 in FIG. 6. The exemplary embodiment shown in FIG. 9A depicts a parallel configured multi-node interlock 900 that can consist of a plurality of inverter interlock nodes 901, perhaps present in each inverter and system connection device interlock node 907 present in the system connection device. The switched interlock voltage source 910 can then be turned on when the system connection device determines that grid conditions are nominal. The pull-up impedance 908 allows one or more interlock nodes to pull down the interlock signal while limiting interlock current. Each inverter interlock portion is comprised of a normally closed shunt pull-down element 906 that may be opened when said inverter is ready to process power. The interlock nodes also contain interlock state-measuring components including a load-limiting impedance 902 and isolated device detector 904. Operation of the multi-node interlock 900 allows any device to prevent or interrupt operation of other devices in the series string whenever such device encounters a fault condition, or such device loses power.

The exemplary embodiment of a series configured multi-node interlock 950 shown in FIG. 9B is an alternative to the parallel multi-node interlock shown in FIG. 9A. The series multi-node interlock is comprised of an interlock source portion 961, contained within the system connection device, and a plurality of inverter interlock portion 951 contained within each inverter. The interlock source portion may be comprised of a current-limited switched interlock voltage source 964 that may be turned on when the system connection device determines that system conditions are nominal, and interlock current detection device 962. Each inverter interlock portion is comprised of a voltage divider impedance element 954, differential voltage detector 952, normally open interlock string severance switch 956, and interlock bypass switch 958.

In a manner like the parallel multi-node interlock, the operation of the series configured multi-node interlock allows for shutdown of the entire string of inverters should any inverter open its interlock string severance switch. This could happen because the inverter determines the presence of a serious fault, or the inverter suffers a loss of power. The series multi-node interlock open circuit condition is visible to the inverters as a lack of voltage and to the system connection device as a lack of interlock current. The series multi-node interlock has the additional capability to allow any of the inverters to take itself “off-line” by closing the bypass switch while keeping the severance switch closed. In such a condition the inverter shorts itself out of the interlock string while allowing power-circuit current to flow unimpeded without the addition of power by said inverter Since a minimum number of inverters is required to synthesize the imposed system voltage, if too many inverters are off-line, the impedance of the series interlock string drops to a level where the increased interlock current may be detected by the system connection device, and it can shut down the entire string.

The series multi-node interlock source portion switched voltage source may be a de source, an ac source, or a combination of de and ac signals. The signal may include a high-resolution AC electrical power delivery network voltage signal, thereby allowing the series multi-node interlock to act as both an interlock and as the line reference distribution and sensing input. In such an arrangement, the inverter interlock differential voltage measurement provides to each inverter information pertaining to both interlock state and real-time grid voltage. During the previously described condition where an inverter takes itself off-line while allowing the remainder of the string of inverters to continue operation, the inverter's interlock shorting switch re-apportions the voltage divider reference voltage among the other inverters. Since the other inverters in the string may not be directly aware of said inverter's offline situation, the other inverters may exhibit non-coordinated collective action even during such a contingency.

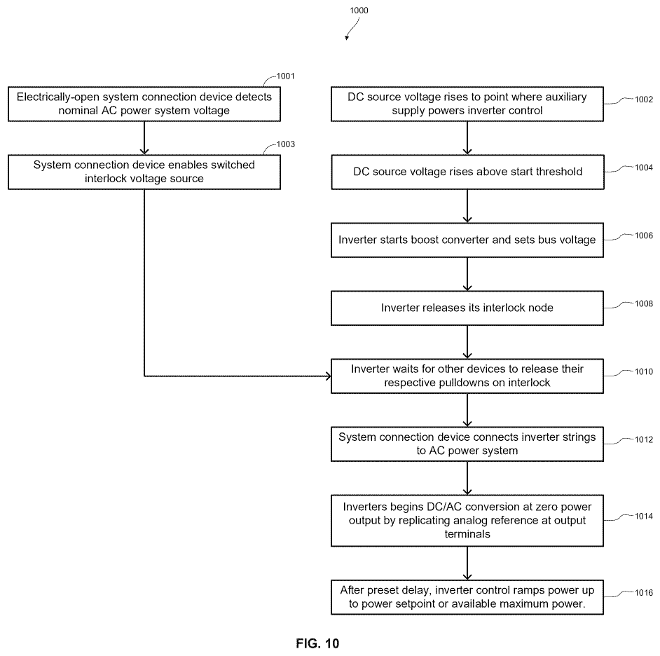

Referring to FIG. 10, shown is a flowchart depicting one method by which one embodiment of a plurality of series-connected DC-AC inverters and a system connection device may be operated. As shown, the system connection device waits for, is eventually provided with, and detects the application of nominal AC system voltage (Block 1001). Once this occurs, the system connection device connects the switched interlock voltage source which in turn provides voltage to the multi-node interlock connected to the inverters in the strings associated with the system connection device (Block 1003). Similarly, each inverter waits for its DC power source voltage to rise to a minimal permissible level for the inverter auxiliary power supply to operate and provide power to its control (Block 1002). The inverter, now awake, waits for the DC power source voltage to rise above a start threshold (Block 1004). Once the DC source voltage rises above the start threshold, the DC-DC converter may be started in bus voltage regulation mode and the bus is charged to its setpoint voltage (Block 1006). Assuming conditions are assessed by the inverter as nominal, the respective interlock node of the multi-node interlock is released (Block 1008). Each inverter then waits for the other inverters to release their respective interlock nodes and for the system connection device to enable the switched interlock voltage source (Block 1010). Once the interlock is satisfied, the system connection device closes its switches thereby connecting the AC power system to the string(s) of inverters for both power connections and the analog reference (Block 1012). Each inverter waits for and detects the presence of the analog reference and zero-power output voltage in a permissible range and starts switching the inverter with a zero-power setpoint (Block 1014). After a preset delay, each inverter presumes that the other inverters have done the same and begins to slowly ramp up power in its DC-DC converter and its periodically signed, sine-squared real-time power controller (Block 1016). If any inverter sees this slow ramp of current, consisting of appropriate magnitude and phase, prior to the expiration of its preset delay, the inverter truncates its delay and begins its own power export.

Each inverter may assert its interlock node in the case of any aberrant condition or loss of input source voltage. Similarly, the system connection device may open the interlock, system voltage power connections, and analog reference connections in response to the interlock being asserted by any other device, a loss of nominal condition in the AC power system, or other aberrant condition such as a PV array ground fault or arc fault.

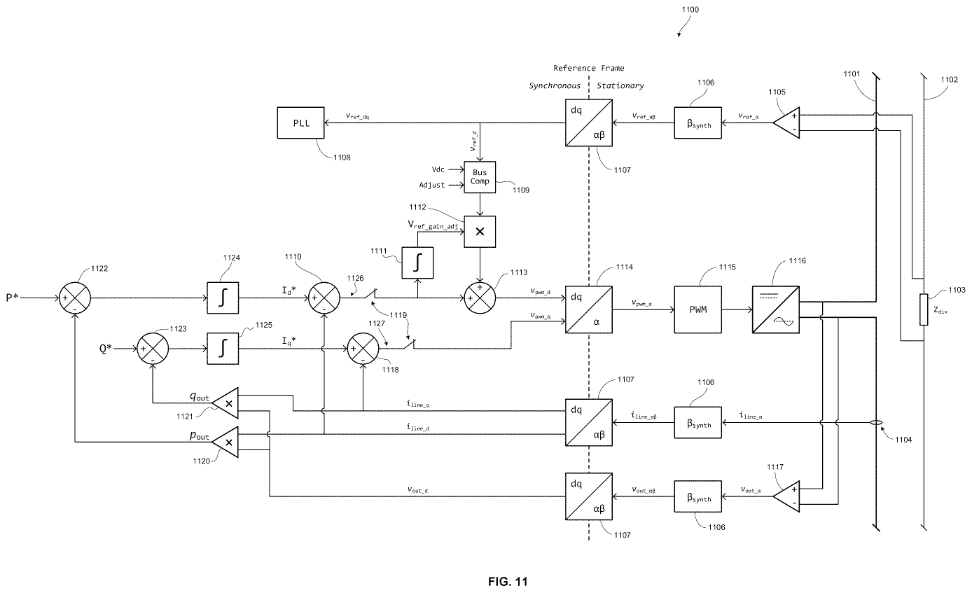

Referring to FIG. 11, it is a control diagram of an exemplary embodiment of control portion 1100 that may be used to implement inner-loop aspects of control portion 605 depicted in FIG. 6 (where inner-loop refers to the fastest layer of control which is connected to the modulator directing the switching network of the inverter) where an autonomous series generative AC device may be responsive to a generative AC device control 1100. 1100 may be characterized as a generative AC device control responsive to an AC system voltage data input and the real-time device output power data input. As shown in the embodiment, voltage reference line 1102, alternatively described as a real-time AC electrical power delivery network voltage data input, presenting to the inverter a precise AC electrical power delivery network apportioned voltage where a substantially accurate voltage signal with respect to phase, magnitude, and waveshape is connected to the AC electrical power delivery network voltage input divider impedance 1103. The voltage divider impedance is connected to the high-resolution AC electrical power delivery network voltage input measurement amplifier 1105. 1102, 1103, and 1105 act as an input for real-time AC electrical power delivery network voltage information to the controller. The single-phase voltage output of the measurement amplifier, referred to as V_{ref_α}, which precisely mimics the dynamic, real-world AC electrical power delivery network voltage waveshape and timing, is used in upper beta-synthesis element 1106 to create a 90° shifted version of itself referred to as V_{ref_β}. The beta value may be created through use of a delay buffer in 1106. Alternatively, a gain-compensated filter may create the beta value which may be achieved either in hardware or software. The V_{ref_αβ} signal pair is transformed from the stationary reference frame to the synchronous reference frame in upper stationary to synchronous reference frame transformation element 1107. The now transformed V_{ref_dq} is used by the phase-lock-loop (PLL) 1108 as a high-resolution AC electrical power delivery network voltage PLL input and as a high-resolution AC electrical power delivery network voltage feed-forward input to bus compensation component 1109. The bus compensation component, or any other part of the feed-forward loop, may have an externally directed adjustment gain for a reference voltage gain compensator with an output connected to the reference voltage gain compensator 1112, with an output connecting to feed-forward loop and feedback loop summing amplifier 1113. The PLL adjusts a trigonometric reference angle used by the reference frame translators to drive the V_{ref_q} to zero. To do this, the high-resolution AC electrical power delivery network voltage PLL input may be considered to be a substantially instantaneous magnitude input.

The current feedback loop is comprised of the real-time current measurement input device 1104, a β-synthesis component middle element 1106, a reference frame transformation component middle element 1107, amplifiers 1110, 1118, and feedback disconnect components 1119. The direct-axis current component 1126 is connected to an integrator 1111, which in turn controls the gain of gain compensator 1112, and a summing amplifier 1113. The output of 1113, as well as the output of the quadrature axis current amplifier 1118, which is the quadrature axis current component 1127, may be connected to a synchronous to stationary reference frame conversion element 1114, the output of which is used by the pulse width modulator control (PWM) 1115 and the inverter 1116, which may be ultimately responsive to real-time reference voltage feed-forward, the real-time output voltage feedback, and the real-time line current feedback. The real-time inverter output voltage measurement input 1101 is connected to input measurement component 1117 which is connected to a β-synthesis component lower element 1106 which is connected to a reference frame transformation component lower element 1107, which when combined with direct and quadrature axis current may be multiplied in multiplier components 1120 and 1121 respectively to create real and reactive device output power feedback input quantities respectively. Multiplier component 1120 in concert with the output voltage measurement and the line current measurement may be collectively described as a real-time AC device output power data input which provides information regarding a real-time AC device output power. The multiplier components may be connected to amplifier components 1122 and 1123 and subtracted from real and reactive power setpoint values, respectively. The outputs of the real and reactive power amplifiers may be fed to integrators 1124 and 1125 respectively whose outputs are the direct and quadrature current setpoints to the current feedback loops.

Much of the difficulty of designing a controller for a series-connected inverter has to do with starting a plurality of inverters and connecting it to the AC power system. Prior art describes a control that transmits a synchronization signal imposed on the AC output line, connects the AC output line to the AC power system and then turns on the inverters. This approach is undesirable in that neither the proper operation of the individual inverters, nor a summed string voltage that matches the AC system voltage has been confirmed prior to closure of the switch joining the string to the AC system. The proposed controller 1100 has several unique features that realize these benefits. The feedback loop disconnect switches 1119 may be responsive to operational mode and open the direct and quadrature axis line current feedback loops and reset integrators 1124, 1125, and 1111. Opening controller feedback loops is generally very rare and typically unadvisable. In this circumstance, prior to closure of the AC switch in the system connection device, when line current must be zero, opening the feedback loops is permissible and necessary given that even a zero setpoint to the loops, due to slight measurement errors, would likely cause instability. From a system perspective, a plurality of inverters is each responsive respectively to a plurality of inverter controls that contain a feedback element and a disconnect for that element which is operative (disconnected) when the string and device voltages are being assessed by an active evaluator function prior to connection the AC power system. Once the AC switch is closed, the loops are closed. However, prior to AC switch closure, an inverter creates a duplicate of its apportionment of the AC electrical power delivery network voltage as indicated by its received AC electrical power delivery network voltage input (line reference). While the measured line reference is a sufficiently accurate duplicate of the AC system voltage for this purpose, as it may use actual voltage values from the AC electrical power delivery network, internal scaling must be performed to account for changes within the inverter such as time-varying bus voltage. This occurs within bus compensator element 1109 and is relatively common in parallel-connected inverters. However, parallel-connected inverters always have closed current feedback loops when the inverter is switching, so compensation within the feed-forward loop is not especially important as it is here. The bus compensator element contains an additional, and unique, aspect which is an adjustment multiplier that may be adjusted by the system connection device if it detects a mismatch in the summed string voltage and the AC system voltage prior to AC switch closure.

After the AC switch closure, inverter current feedback loops may be closed allowing for inverter control that is responsive during power delivery by a plurality of inverters. Normally, a current controller would not work well in a series-connected string where an individual inverter has little control over string current. While the current control may run a persistent value that re-apportions inverter output voltage and thereby power, it may be preferable to have such voltage re-apportionment, as a function of power differences among the inverters in the string, performed by a voltage controlling component instead of a current controller running a persistent value. This problem is solved by a current component integrator 1111 and feed-forward scaling element 1112 as the feed-forward function is inherently associated with output voltage. This is unique in two respects. Firstly, a feedback loop does not typically alter a feed-forward loop and, secondly, control behavior is typically additive, not multiplicative as shown in 1112. The importance of multiplicative behavior is that it is beneficial that the original waveshape of the feed-forward be retained. A multiplicative approach, of modest control speed, satisfies this constraint while a summing amplifier would not, thereby allowing for substantially instantaneous, dynamic, full-cycle, delivery network voltage waveform mimicking generative AC device control.

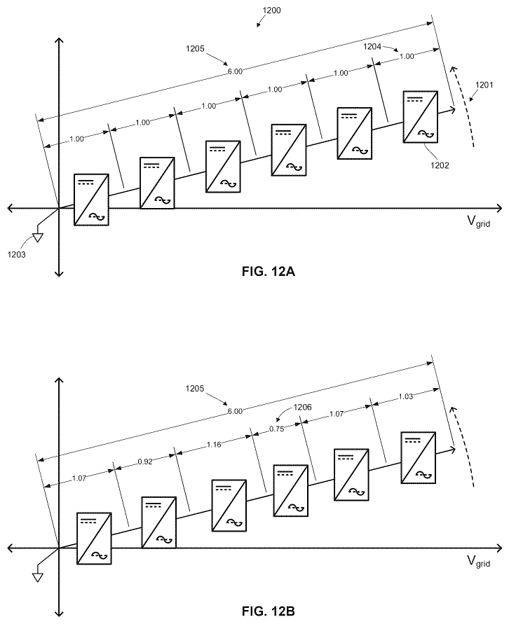

Referring to FIG. 12A and FIG. 12B are phasor diagrams 1200 describing the behavior of a string of inverters operating with homogeneous and heterogeneous power outputs, respectively. Each inverter 1202 is depicted in its relative position on a string connected to a single-phase system voltage shown to rotate 1201 around the electrical system ground 1203. Respective normalized output voltages 1204 are shown to sum to the overall normalized system voltage 1205. FIG. 12A depicts series-connected inverters operating with homogeneous power output thereby resulting in identical output voltages. FIG. 12B depicts the same inverters operating with heterogeneous power output thereby resulting in output voltages 1206 that may not be equal. Such behavior may be extended to the extent that a given inverter may present zero, or even reverse, voltage with respect to other inverters on the string while still processing a shared current. The single-phase depiction shown in FIG. 12A and FIG. 12B may be extendable in both the number of inverters potentially placed in a string as well as other power system phase arrangements such as, but not limited to, split single-phase, 2-phase, 3-phase wye, and 3-phase delta.

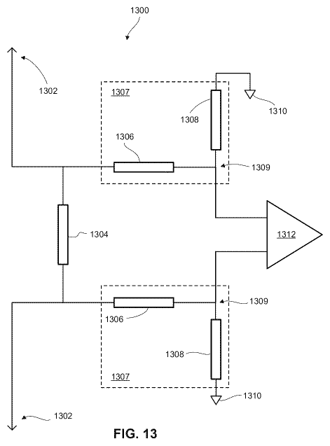

As shown in FIG. 13, an exemplary embodiment of a reference voltage measurement device and divider impedance 1300 used in the system shown in FIG. 6 as elements 628 and 629, respectively. The high-resolution AC electrical power delivery network voltage input 1302 is connected to the voltage divider impedance 1304 at a first and second connections and respective measurement voltage divider networks 1307. The voltage divider networks may be comprised of impedance pairs 1306, 1308. The reference for the voltage divider networks is the local internal reference point 1310, whereas the voltage divider outputs 1309 may be connected to the reference voltage measurement amplifier device 1312. A divider network 1307 serves two purposes: firstly to provide a sufficiently high impedance between the voltage to be measured, which contains both differential and common-mode aspects, and the voltage measurement device which may not be directly tolerant of the magnitude of the voltage to be measured; and secondly, to provide a connection, through an impedance, between the reference voltage and the inverter local reference (which may be thought of as a local ground, albeit one that has no direct relationship with remote, or earth, ground). However, these two purposes may be in conflict. The former benefits from a higher overall impedance for 1307 and the latter benefits from a lower impedance due to the need to connect the local reference to the line reference despite the presence of admittances in other parts of the inverter that attempt to counter the inverter from being referenced this way. Optimal ranges for impedance 1307 may be around 100 kOhm. If component 1300 was for the single purpose of connecting the line reference through an impedance to the local reference, then it may be permissible to use a lower impedance 1307 and to connect it to either side, or both sides, of the divider impedance 1304.

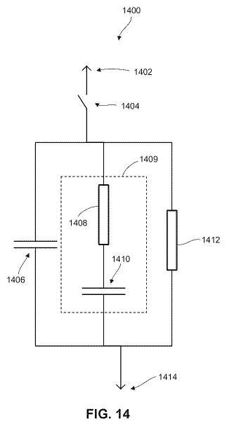

As shown in FIG. 14, an exemplary embodiment of an inverter output shunt voltage assembly 1400 used in the system shown in FIG. 6 as element 624. It contains a filter capacitor 1406 in parallel with a bleed resistor 1412 in parallel with a damper assembly 1409 comprised of a damper resistor 1408 in series with damper capacitor 1410. The entirety of these paralleled elements may be connected to a severance switch 1404. The severance switch permits the filter assembly to be disconnected from the inverter output lines when the output is non-energized.

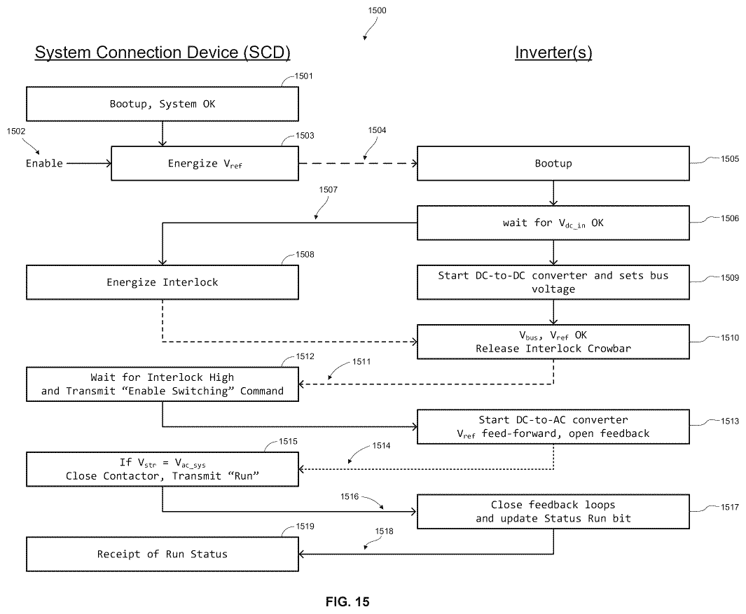

Referring to FIG. 15, shown is a flowchart 1500 depicting one method by which an embodiment of a plurality of series-connected inverters and a system connection device may be operated. From a completely powered-down state, the described start sequence begins with booting up the various devices. However, the seemingly mundane step of powering and booting up a series-connected inverter merits additional scrutiny. Prior art says little or nothing regarding how an inverter should be initially powered, leaving a reader to assume that it is powered by the DC source. While simple, this creates a problem if the DC source is a photovoltaic panel. When presented with some serious condition such as a failed inverter component that results in a short circuit of the DC source, some sources such as batteries may provide excessive current allowing operation of a fuse or other overcurrent protective device. However, photovoltaic power sources express short circuit current that may be hardly greater than expected full load current rendering fuses ineffective. This can result in uninterrupted fault current that causes increasing damage over time with a significant chance of a resulting fire. For this reason, it may be desirable to place the total DC input power disconnect switch 633 as the first inverter component connected to the DC source so it may be opened under aberrant conditions. More specifically, the post individual source total DC input power disconnect is positioned in the system so that no device or system utilizable power is drawn (or sourced) from the side of the disconnect shared with the DC power source. Typically, even if a device which is connected to a PV power source (series-connected inverter, parallel-connected inverter, optimizer, severance switch, etc.) has a disconnection switch similar to 633, components are placed between the switch and the source that are used to provide auxiliary power to the device. While convenient, the risk of failure of these components compromises the intended benefit of having the switch. However, under the proposed switch configuration, if the DC switch is open there is no way to provide power to the inverter auxiliary supply from the DC source and therefore no way to boot the inverter. The solution presented here is to provide inverter auxiliary power from at least one source other than the DC source. This alternate supply may be the primary source of power to the auxiliary input or may be a temporary source used until the inverter can bootup, close the DC switch, and transition to the DC source for its auxiliary power needs which may be characterized as a plurality of individual generative AC device-respective operational power sources comprised of a respective plurality of individual generative AC device-respective operational power source transition systems. The alternate power source for the inverter auxiliary input may be the AC output string itself. The AC output string may be energized, allowing bootup and subsequently de-energized prior to resuming the remainder of the startup sequence. Such a temporary turn-on of the AC output string, from the system connection device, could include a fault-limiting impedance. Alternatively, the alternate power source for an inverter auxiliary input may be the voltage reference line where supplied power from the reference line may be configured to provide sufficient power to minimally achieve substantially non-power producing series generative AC device full operation. As such, operation of each of the plurality of inverters energizer function is independent of an inverter auxiliary power input. An additional benefit of such a multi-source auxiliary power input system includes the ability to completely shut down a device and still retain the ability to restart it. At least one inverter may be commanded to open its DC input switch, thereby removing the DC source of auxiliary power. This, in combination with de-energization of the other sources of auxiliary power input proposed here results in a completely powered down state. This unique capability is taught against by common practice in the PV industry where keeping sufficient auxiliary power to at least operate processors within a device has been historically viewed as desirable, if not imperative.

An embodiment of a bootup and startup sequence described in 1500 is as follows: the system connection device, if not already powered, is powered and booted up 1501, receives 1502 a user-enable signal issued by an external supervisory controller or person and energizes 1503 the line voltage reference, thereby providing information to the inverters regarding an AC electrical power delivery network voltage. This may further be characterized as an energizer for an AC generative series string comprised of operative substantially non-power producing, individually autonomously self-controlled individual generative AC devices. The inverters, if not already booted up, receive 1504 power from the line voltage reference and bootup 1505, including closing DC source switches. Inverters then wait 1506 for proper DC voltage (in the case of photovoltaics, this amounts to waiting for the sun to come up). When DC voltage is above a pre-programmed start threshold, an inverter regulates 1509 its bus voltage as necessary and communicates 1507 across the communications path 631, 1852 that it is ready. The system connection device energizes 1508 the interlock and an inverter, assuming there are no faults, releases 1510 its interlock shunt. When the inverters have done this, the interlock is satisfied (goes high) 1511 and the system connection device issues 1512 the “enable” command. An inverter then initiates switching 1513 thereby energizing its output using feed-forward control with feedback disconnect switches 1119 open. Since the string is not yet connected to the AC power system, each inverter is generating a substantially non-power producing AC output voltage thereby establishing an energized string output that is in a substantially non-power producing state. If the system connection device senses 1514 that inverters are operating properly and evaluates string voltage as sufficiently matched to the AC electrical power delivery network voltage, then it operates its active AC connection element 1515 and transmits 1516 the “run” command to the inverters as the active connection element and the inverters may be operationally controlled apart from one another. An inverter closes 1517 its feedback loops, updates 1518 status to “running” which is received 1519 by the system connection device. This startup sequence may be reversed to turn-off the system, with the added benefit of allowing for complete de-energization of DC and AC circuitry between the outputs of DC input sources and the system connection device.

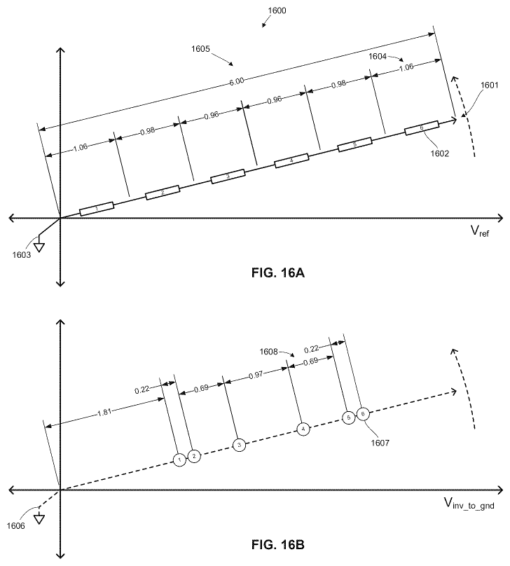

Referring to FIG. 16A and FIG. 16B are phasor diagrams 1600 describing the voltage referencing behavior of a string of series-connected inverters with non-energized outputs. A system of inverters with a permanently connected output string may, when outputs are energized and processing homogeneous power among the respective individual inverters, create the uniform voltage output behavior described by FIG. 12A. Furthermore, FIG. 12A shows that the position each inverter has on the applied system phasor is a function of the location of the inverter in the string. While the heterogenous power output depicted in FIG. 12B shows non-uniform voltage outputs among the inverters, the inverters may be only modestly out of position with respect to their ideal locations on the applied system phasor. However, when the inverter outputs are not energized as shown in 1600, the positioning of the inverters on the phasor may be accomplished through the applied high-resolution AC electrical power delivery network voltage 1601. When the inverter output is energized, to prevent the reference voltage and the output voltage from conflicting, a non-trivial impedance 1307 may be placed between a connection from the high-resolution AC electrical power delivery network voltage input and the inverter local reference 1310 where such impedance may be between at least one input to the local as shown in 1300. However, under non-energized output conditions with inverter switches 615 open and the DC bus charged above the reference peak voltage, any admittances in the inverter AC output and/or stray admittances, either conductance or capacitive susceptance, from the inverter to remote ground may compromise the ability of the high-resolution AC electrical power delivery network voltage input to properly position an inverter on the system phasor. Firstly, as shown in FIG. 16A, the applied and measured voltages 1604 may not be identical even though the reference voltage divider impedances 1602 may be identical. Secondly, the local board references 1607, which corresponds to 1310 in FIG. 13, may be even more severely pulled out of position than the imbalances evident in 1604. Both imbalances grow worse as the number of inverters is extended beyond the six shown in 1600 and quickly become unworkable.

There may be several possible solutions to minimize the unwanted effect of admittances creating the asymmetries shown in 1600. Firstly, a reference voltage divider input impedance 1306 tolerable of such high imbalances could be used. However, high voltage, high common-mode rejection ratio measurement approaches may be prohibitively expensive. Secondly, any admittance within each inverter causing this problem could be isolated with a blocking element such as a switch. While severance switches could be placed between the outputs of each inverter, such switches pose significant problems with respect to failure mode ductility. Given the flexibility series-connected inverters exhibit with respect to permissible string length, it is easy to conceive of a scenario where the system voltage may be far more than any single severance switch, assuming a reasonable cost, could likely tolerate should it ever open for any reason during operation. Alternatively, a switch severing only the AC output admittance like 1404, while leaving the connections between inverters intact, does not impose significant failure ductility concerns. While output filters of inverters may be considered integral to their designs and standard practice teaches away from ever disconnecting them, an exemplary embodiment of this is shown in FIG. 14. With respect to parasitic admittances to remote ground, these may be minimized, blocked with a common-mode filter, or also switched if practicable. Assuming the existence of some modest, and unavoidable, admittance to remote ground, it may be important to select the voltage divider total impedance 1307 sufficiently low as to effectively “drive” these parasitic admittances.

In addition to the problem of excessive admittances, is an electrical effect imposed on the output terminals by the inverter topology. When switches 615 are open and the bus is below nominal voltage, a rectification effect occurs. While it may be considered an admittance, as it also disrupts proper phasor positioning of the inverter when the inverter output is off, it exhibits non-linear behavior and perhaps is better categorized under the more encompassing term “electrical effect”. Additionally, the preferred remedy for this may not be a severance switch but rather to assure that a parameter, the inverter bus voltage, is maintained at nominal value. Given this breadth of phenomena that may disrupt proper phasor positioning during times when the output is non-energized, a generalized solution may be characterized as controlling or reducing at least one established parametric electrical effect by an intermittently operative means or system at selected times that would otherwise adversely impact proper phasor positioning of the generative AC output. Furthermore, the selected times at which the controllable, intermittently operative, AC output-parametric electrical effect reduction system operates, both comprises at least some occasions when an AC generative series string is in a substantially non-power producing state. Such an occasion may comprise a portion of a series generative AC device startup time. Furthermore, a non-power producing state may include a state where the string is referenced to substantially full system voltage and insubstantial current. Additionally, effective phasor positioning is configured and maintained, under insubstantial current for at least one plurality of series generative AC devices during inverter operation prior to connection with the AC electrical network. What is proposed here may be characterized as the controllable, intermittently operative parametric effect reduction of a plurality of individual generative AC devices.

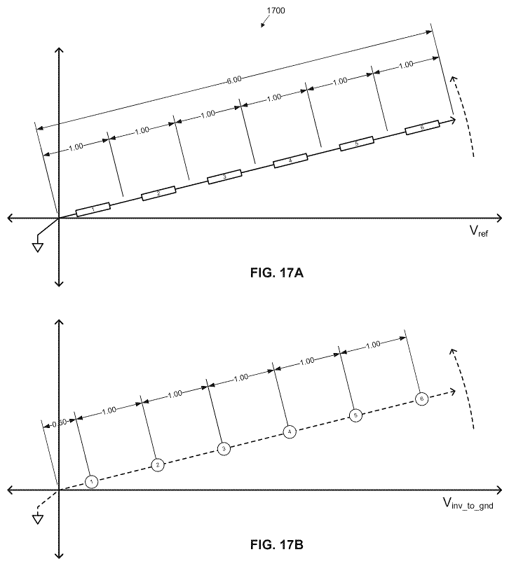

Referring to FIG. 17A and FIG. 17B are phasor diagrams 1700 describing the behavior of a string of inverters with non-operational outputs which are instead referenced on the system voltage phasor by the reference voltage after inverter AC output admittances have been severed. As shown, the selective use of switch 1404 when the inverter output is not energized results in symmetrical applied reference voltages and local reference position for each inverter. The proper referencing position of the inverters may be confirmed with a string output evaluator prior to energizing the outputs of the plurality of inverters and connection to the AC system. Additionally, a component of the string evaluator may be an individual series generative AC device condition output evaluator as individual inverter outputs may be independent of the overall string output.

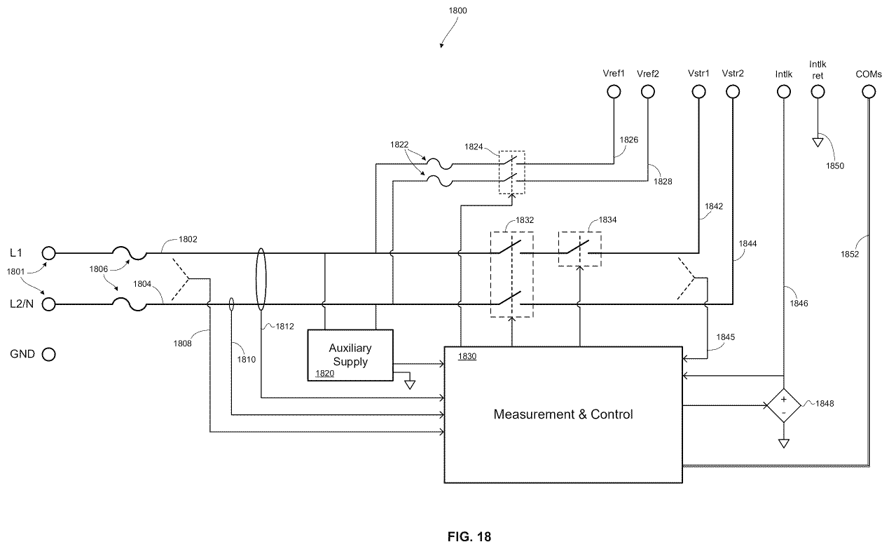

As shown in FIG. 18, an exemplary embodiment of a system connection device 1800 used in the system shown in FIG. 5 as element 510. The AC electrical power delivery network is connected to the system connection device at line connections 1801. The line connections may be further connected to fuses 1806, which may be connected to internal lines 1802 and 1804 respectively, which may be connected to line voltage measurement 1808, line current measurement 1810, common-mode current measurement 1812 capable of measuring both line and reference line common-mode current, input to auxiliary supply 1820, reference voltage line current-limiting fuses 1822, and switch 1832. Reference line fuses may be further connected to reference line switch 1824 that applies system voltage to the line reference, which may be connected to high-resolution AC electrical power delivery network voltage input connections 1826 and 1828. Line switch 1832 is further connected to fast line power disconnect switch 1834. The fast line switch is further connected to a first power connection 1842, while line switch 1832 is further connected to a second power connection 1844. The first and second connections comprise the AC generative series string output. Between the power connections is the AC generative string output sensor 1845. An interlock string 1846, with return 1850, is connected to switchable source 1848. A possibly serially connected communications line from a string of inverters 1852 may be connected to the control and may be combined in the same cable or cord as the interlock, string output, or voltage reference. Alternatively, digital communications signals may be imposed on the reference line. Each inverter controller acts as a data server to the communications arrangement with the system connection device as the sole data client. The controller 1830 has a power input from the auxiliary supply, inputs from the line voltage measurement, line current measurement, common-mode current measurement (ground fault detector), string voltage measurement, and interlock, and outputs to the line reference switch, the line switch, the fast line switch, and the interlock controlled-source. Controller 1830 also, upon receipt of reference voltage measurements from the inverters, may execute a string output evaluator function responsive to the string output voltage sensor to confirm proper phasor positioning of the inverters at times when the string is in a substantially non-power producing state prior to issuing an enable output command to the inverters and subsequent connection to the AC system with the decisionally-controlled AC connection element responsive to the output evaluator function. The controller may, using measurement information from the output power string and voltage reference line, implement an arc fault detection function. A similar embodiment of a system connection device may be a polyphase variant, further comprised of additional AC system connections, fuses (or other overcurrent protection element), voltage measurements, current measurements, line reference connections and signals, and string power connections. The system connection device also measures common-mode current and reported line reference voltages from the plurality of inverters to assess against permissible limits the proper referencing of the inverters on the voltage phasor when inverter outputs are not energized.

A series-connected inverter, should it turn off when the string is carrying power in a way that results in switches 615 turning off, may be susceptible to damage as the components of which the device is comprised may not be typically tolerant of the AC system voltage. As such, the interlock may be connected substantially directly to the fast line disconnect switch 1834 input as it is the purpose of the fast line switch to separate the string from the AC system prior to damage occurring. For regulatory reasons, the line disconnect switch 1832 is typically electro-mechanical in nature and insufficiently fast for this purpose. While common practice teaches away from putting multiple switches in series, it may be necessary to have a response to an interlock event faster than that which can be provided by an electro-mechanical switch.

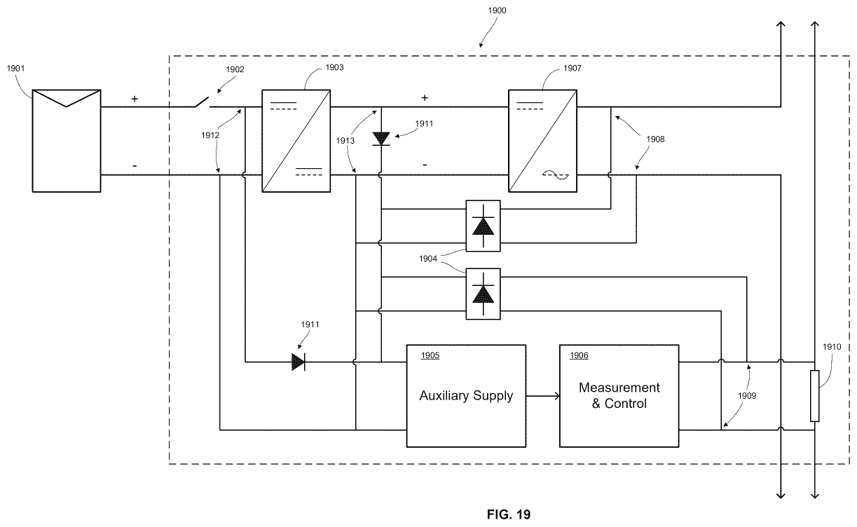

As shown in FIG. 19, an exemplary embodiment of a multi-source input auxiliary power source for an AC power generation system 1900, which may be series or parallel connected and which may comprise a DC-DC converter 1903, a DC-AC inverter 1907, the auxiliary power source 1905 input may be fed from the DC input power source connections 1912, the AC voltage output source 1908 (from which power is supplied), the AC reference voltage input source 1909, or the DC bus source connections 1913. The DC auxiliary inputs may be configured for unidirectional current flow using diodes 1911. The AC auxiliary inputs are rectified with rectifier components 1904 which may allow only unidirectional current and may be capable of being disconnected as directed from the controller 1906. Any combination of two or more auxiliary inputs may be configured, but in some cases, based on characteristics of the DC-DC converter and/or DC-AC inverter, some inputs options described here may be redundant. Voltages may be coordinated so that at times a preferred input may produce a voltage higher than the other inputs resulting in substantially zero current contribution from them with uninterrupted transition between auxiliary input sources and functionally uninterrupted auxiliary power to the inverter. Conversely, the power source transition system may include an active operational switch or connection element function of rectifier 1906. This system allows operational transition from a first source, for bootup and non-switching inverter state, to a second source, for non-power producing switching state and power producing state, and may be especially important as use of auxiliary input power drawn from the AC reference voltage input may compromise its primary function of providing highly accurate high-resolution AC electrical power delivery network voltage information. In such a case, the power source would be for temporary, non-power producing bootup purposes, after which the auxiliary supply would draw its power from another source. The total DC input power disconnect 1902 may be opened by a command received by the inverter controller in concert with an external de-energization of the AC auxiliary power inputs resulting a complete de-energization of the inverter system from the DC sources to the system connection device. Such complete de-energization may not be possible without the ability to draw auxiliary supply input power from a source(s) other than the primary DC input power source. The described configuration and operation are extendable to a system comprised of a plurality of DC input power sources each connected respectively to a plurality of AC power generation systems, each containing at least one total DC input disconnect. Collectively, the plurality of individual source total DC input power disconnects may function as a global total DC input power disconnect.

While the application has been described in connection with some embodiments, it is not intended to limit the scope to the particular form set forth, but on the contrary, it is intended to cover such alternatives, modifications, and equivalents as may be included within the spirit and scope of the application. Examples of alternative claims may include the following clauses:
1. An operational system for series generative AC devices comprising: a plurality of autonomously self-controlled, series generative AC devices; a series configured connection system through which said plurality of autonomously self-controlled, series generative AC devices are connected in a string; and a series-additive composite AC voltage output through which power from said plurality of autonomously self-controlled, series generative AC devices is supplied.
2. An operational system for series generative AC devices as described in clause 1 or any other clause wherein said plurality of autonomously self-controlled, series generative AC devices comprises a plurality of non-centrally directed control series generative AC devices.
3. An operational system for series generative AC devices as described in clause 1 or any other clause wherein said plurality of autonomously self-controlled, series generative AC devices is configured so each series generative AC device is not responsive to or aware of the control for any other series generative AC device.
4. An operational system for series generative AC devices as described in clause 1 or any other clause wherein said plurality of autonomously self-controlled, series generative AC devices comprises a plurality of per cycle autonomous self-controlled series generative AC devices.
5. An operational system for series generative AC devices as described in clause 1 or any other clause wherein said plurality of autonomously self-controlled, series generative AC devices comprises a plurality of series generative AC devices that are controlled only by control circuitry at each individual device.
6. An operational system for series generative AC devices as described in clause 1 or any other clause and further comprising an active AC generative series string connection element wherein said plurality of autonomously self-controlled, series generative AC devices comprises a plurality of series generative AC devices that are operationally controlled apart from said active AC generative series string connection element.
7. An operational system for series generative AC devices as described in clause 1 or any other clause wherein said plurality of autonomously self-controlled, series generative AC devices comprises a plurality of series connected DC-AC inverters.
8. An operational system for series generative AC devices as described in clause 7 or any other clause wherein said plurality of series connected DC-AC inverters comprises a plurality of autonomously self-controlled, heterogenous AC output voltage, series connected DC-AC inverters.
9. An operational system for series generative AC devices as described in clause 1 or any other clause wherein said plurality of autonomously self-controlled, series generative AC devices comprises a plurality of autonomously self-controlled, heterogenous AC output voltage, series generative AC devices that sum to an AC electrical power delivery network voltage.
10. An operational system for series generative AC devices as described in clause 1 or any other clause wherein said plurality of autonomously self-controlled, series generative AC devices do not communicate with each other.
11. An operational system for series generative AC devices as described in clause 1 or any other clause and further comprising a high-resolution AC electrical power delivery network voltage input.
12. An operational system for series generative AC devices as described in clause 1 or any other clause wherein said high-resolution AC electrical power delivery network voltage input comprises an analog AC electrical power delivery network voltage input.
13. An operational system for series generative AC devices as described in clause 12 or any other clause wherein said analog AC electrical power delivery network voltage input accurately represents the AC electrical power delivery network voltage.
14. An operational system for series generative AC devices as described in clause 11 or any other clause wherein said series-additive composite AC voltage output and said high-resolution AC electrical power delivery network voltage input are contained within the same cable.
15. An operational system for series generative AC devices as described in clause 11 or any other clause wherein said high-resolution AC electrical power delivery network voltage input is selected from: a single-phase high-resolution AC electrical power delivery network voltage input; and a poly-phase plurality of high-resolution AC electrical power delivery network voltage inputs.
16. An operational system for series generative AC devices as described in clause 1 or any other clause wherein said plurality of autonomously self-controlled, series generative AC devices comprises dynamically heterogenous AC output voltage, series generative AC devices.
17. An operational system for series generative AC devices as described in clause 1 or any other clause wherein each of said plurality of autonomously self-controlled, series generative AC devices is selected from: a single phase plurality of autonomously self-controlled, series generative AC devices; and a poly phase plurality of autonomously self-controlled, series generative AC devices.
18. An operational system for series generative AC devices as described in clause 11 or any other clause wherein said high-resolution AC electrical power delivery network voltage input comprises a series voltage divider configured input.
19. An operational system for series generative AC devices as described in clause 18 or any other clause wherein said series voltage divider configured input comprises a plurality of individual series generative AC device-associated divider impedances.
20. An operational system for series generative AC devices as described in clause 1 or any other clause wherein each of said plurality of autonomously self-controlled, series generative AC devices comprises a bus voltage measurement component.
21. An operational system for series generative AC devices as described in clause 1 or any other clause and further comprising a system connection device.
22. An operational system for series generative AC devices as described in clause 21 or any other clause wherein said system connection device is selected from: a single-phase system connection device; and a poly-phase plurality of system connection devices.
23. An operational system for series generative AC devices as described in clause 21 or any other clause wherein said system connection device comprises at least one disconnection switch for power outputs feeding to the AC electrical power delivery network.
24. An operational system for series generative AC devices as described in clause 21 or any other clause wherein said system connection device comprises at least one high-resolution AC electrical power delivery network voltage input connection.
25. An operational system for series generative AC devices as described in clause 21 or any other clause wherein said system connection device comprises an overcurrent protection element.
26. An operational system for series generative AC devices as described in clause 21 or any other clause wherein said system connection device comprises a ground fault detector.
27. An operational system for series generative AC devices as described in clause 21 or any other clause wherein said system connection device comprises an arc fault detector.
28. An operational system for series generative AC devices as described in clause 7 or any other clause wherein said plurality of series connected DC-AC inverters are selected from: a plurality of uni-directional series connected DC-AC inverters; and a plurality of bi-directional series connected DC-AC inverters.
29. An operational system for series generative AC devices as described in clause 1 or any other clause and further comprising a multi-node interlock.
30. An operational system for series generative AC devices as described in clause 29 or any other clause wherein said multi-node interlock comprises a switchable, current limited source.
31. An operational system for series generative AC devices as described in clause 29 or any other clause wherein said multi-node interlock comprises a fast power disconnection switch.
32. An operational system for series generative AC devices as described in clause 29 or any other clause wherein said multi-node interlock comprises a parallel configured multi-node interlock.
33. An operational system for series generative AC devices as described in clause 32 or any other clause wherein said parallel configured multi-node interlock comprises an isolated device detector.
34. An operational system for series generative AC devices as described in clause 32 or any other clause wherein said parallel configured multi-node interlock comprises a pull-down element.
35. An operational system for series generative AC devices as described in clause 29 or any other clause wherein said multi-node interlock comprises a series configured multi-node interlock.
36. An operational system for series generative AC devices as described in clause 35 or any other clause wherein said series configured multi-node interlock comprises a voltage reference distribution and sensing interlock.
37. An operational system for series generative AC devices as described in clause 35 or any other clause wherein said series configured multi-node interlock comprises: a voltage divider impedance; and a differential voltage detector.
38. An operational system for series generative AC devices as described in clause 35 or any other clause wherein said series configured multi-node interlock comprises an interlock bypass switch.
39. An operational system for series generative AC devices as described in clause 1 or any other clause and further comprising a communications line configured to effect control of at least some activity of said plurality of series generative AC devices.
40. An operational system for series generative AC devices as described in clause 39 or any other clause wherein said communications line comprises a serially connected communications line connected to each of said plurality of series generative AC devices.
41. An operational system for series generative AC devices as described in clause 11 or any other clause further comprising a communications line configured to effect control of at least some activity of a plurality of series generative AC devices, and wherein said communications line, said series-additive composite AC voltage output, and said high-resolution AC electrical power delivery network voltage input, are contained within the same cable.
42. An operational system for series generative AC devices as described in clause 21 or any other clause further comprising a serially connected communications line connected to each of said plurality of series generative AC devices and connected to said system connection device.
43. An operational system for series generative AC devices as described in clause 1 or any other clause and further comprising a plurality of DC input sources, each connected to a separate series generative AC device, wherein said DC input sources are selected from: a plurality of uni-directional DC input sources; and a plurality of bi-directional DC input sources.
44. An operational system for series generative AC devices as described in clause 43 or any other clause wherein each said DC input source comprises a DC input source disconnect configured to disconnect power delivery to each DC input source's separate series generative AC device.
45. An operational system for series generative AC devices comprising: a real-time AC device output power data input; a high-resolution AC electrical power delivery network voltage input; and a generative AC device control responsive to both said real-time AC device output power data input and said high-resolution AC electrical power delivery network voltage data input.
46. An operational system for series generative AC devices as described in clause 45 or any other clause and further comprising an autonomous series generative AC device responsive to said generative AC device control.
47. An operational system for series generative AC devices as described in clause 45 or any other clause wherein said autonomous series generative AC device comprises a series connected DC-AC inverter.
48. An operational system for series generative AC devices as described in clause 45 or any other clause wherein said high-resolution AC electrical power delivery network voltage input is selected from: a non-pure sine AC electrical power delivery network voltage input; a non-derived AC electrical power delivery network voltage input; and a non-presumed AC electrical power delivery network voltage input.
49. An operational system for series generative AC devices as described in clause 46 or any other clause and further comprising a plurality of autonomously self-controlled, heterogenous AC output voltage, series generative AC devices that sum to an AC electrical power delivery network voltage.
50. An operational system for series generative AC devices as described in clause 49 or any other clause wherein said plurality of autonomously self-controlled, series generative AC devices do not communicate with each other.
51. An operational system for series generative AC devices as described in clause 50 wherein each of said plurality of autonomously self-controlled, dynamically heterogenous AC output voltage, series generative AC devices comprises a sine-squared based control input.
52. An operational system for series generative AC devices as described in clause 45 or any other clause and further comprising a plurality of autonomous series generative AC devices, each responsive to a separate generative AC device control.
53. An operational system for series generative AC devices as described in clause 52 or any other clause wherein said plurality of autonomous series generative AC devices comprises a plurality of series connected DC-AC inverters.
54. An operational system for series generative AC devices as described in clause 45 or any other clause wherein said high-resolution AC electrical power delivery network voltage input comprises an AC electrical power delivery network voltage input that accurately represents the AC electrical power delivery network voltage at greater than two accurate points of voltage information per AC cycle.
55. An operational system for series generative AC devices as described in clause 45 or any other clause wherein said high-resolution AC electrical power delivery network voltage input is selected from: an AC electrical power delivery network voltage input that accurately represents the AC electrical power delivery network voltage at greater than 15 accurate points of voltage information per AC cycle; an AC electrical power delivery network voltage input that accurately represents the AC electrical power delivery network voltage at greater than 30 accurate points of voltage information per AC cycle; an AC electrical power delivery network voltage input that accurately represents the AC electrical power delivery network voltage at greater than 100 accurate points of voltage information per AC cycle; an AC electrical power delivery network voltage input that accurately represents the AC electrical power delivery network voltage at greater than 166 accurate points of voltage information per AC cycle; a substantially continuous AC electrical power delivery network voltage input; and an analog input.
56. An operational system for series generative AC devices as described in clause 45 or any other clause wherein said high-resolution AC electrical power delivery network voltage input comprises a real AC electrical power delivery network voltage values.
57. An operational system for series generative AC devices as described in clause 45 or any other clause wherein said high-resolution AC electrical power delivery network voltage input comprises an analog AC electrical power delivery network voltage input that is relative to the precise AC electrical power delivery network voltage.
58. An operational system for series generative AC devices as described in clause 45 or any other clause wherein said high-resolution AC electrical power delivery network voltage input comprises a substantially accurate phase and magnitude AC electrical power delivery network voltage input.
59. An operational system for series generative AC devices as described in clause 45 or any other clause wherein said high-resolution AC electrical power delivery network voltage input comprises a delivery network mimicking AC electrical power delivery network voltage input that substantially, and in real-time, mimics the real world waveform of the AC electrical power delivery network voltage.
60. An operational system for series generative AC devices as described in clause 45 or any other clause wherein said high-resolution AC electrical power delivery network voltage input comprises an actual, dynamic delivery network voltage waveform.
61. An operational system for series generative AC devices as described in clause 46 or any other clause wherein said operational system for series generative AC devices comprises:
a plurality of said generative AC device controls; and
a plurality of similarly phased autonomous series generative AC devices, each responsive to one of said plurality of generative AC device controls
62. An operational system for series generative AC devices as described in clause 45 or any other clause wherein said generative AC device control comprises a generative AC device waveform mimicking control.
63. An operational system for series generative AC devices as described in clause 62 or any other clause wherein said generative AC device waveform mimicking control comprises a full cycle generative AC device control.
64. An operational system for series generative AC devices as described in clause 63 or any other clause wherein said a full cycle generative AC device control comprises a substantially instantaneous generative AC device waveform control.
65. An operational system for series generative AC devices as described in clause 64 or any other clause wherein said substantially instantaneous generative AC device waveform control comprises a substantially instantaneous, dynamic, delivery network waveform mimicking control.
66. An operational system for series generative AC devices as described in clause 65 or any other clause wherein said substantially instantaneous, dynamic, delivery network waveform mimicking control comprises a substantially instantaneous delivery network timing mimicking and substantially instantaneous voltage magnitude mimicking control.
67. An operational system for series generative AC devices as described in clause 45 or any other clause wherein said generative AC device control is responsive during power delivery by a plurality of series generative AC devices.
68. An operational system for series generative AC devices as described in clause 45 or any other clause wherein said high-resolution AC electrical power delivery network voltage input comprises a real-time AC electrical power delivery network voltage measurement input.
69. An operational system for series generative AC devices as described in clause 69 or any other clause and further comprising: a real-time AC electrical power delivery network voltage measurement input; a real-time AC device output voltage measurement input; and a real-time AC device current measurement input.
70. An operational system for series generative AC devices as described in clause 45 or any other clause wherein said real-time AC electrical power delivery network voltage measurement input comprises a real-time AC device output power feedback input.
71. An operational system for series generative AC devices as described in clause 70 or any other clause wherein said real-time AC device output power feedback input comprises a periodically signed AC device output power input.
72. An operational system for series generative AC devices as described in clause 71 or any other clause wherein said periodically signed AC device output power input comprises an alternatively signed, sine-squared based control input.
73. An operational system for series generative AC devices as described in clause 45 or any other clause wherein said high-resolution AC electrical power delivery network voltage input comprises a high-resolution AC electrical power delivery network voltage feed-forward input.
74. An operational system for series generative AC devices as described in clause 73 or any other clause wherein said high-resolution AC electrical power delivery network voltage feed-forward input comprises a high-resolution AC electrical power delivery phase-locked-loop input.
75. An operational system for series generative AC devices as described in clause 74 or any other clause wherein said high-resolution AC electrical power delivery phase-locked-loop input comprises a substantially instantaneous AC electrical power delivery network phase angle phase-locked-loop input.
76. An operational system for series generative AC devices as described in clause 75 or any other clause wherein said high-resolution AC electrical power delivery phase-locked-loop input comprises a substantially instantaneous AC electrical power delivery network voltage magnitude phase-locked-loop input.
77. An operational system for series generative AC devices as described in clause 45 or any other clause and further comprising a low-gain waveshape correction input.
78. An operational system for series generative AC devices as described in clause 77 or any other clause wherein said low-gain waveshape correction input comprises a real-time AC device current measurement input.
79. An operational system for series generative AC devices as described in clause 78 or any other clause wherein said real-time AC device current measurement input comprises: a peak detector; and a waveform synthesizier.
80. An operational system for series generative AC devices as described in clause 47 or any other clause further comprising a multi-node interlock.
81. An operational system for series generative AC devices as described in clause 80 or any other clause wherein said multi-node interlock comprises a parallel configured multi-node interlock.
82. An operational system for series generative AC devices as described in clause 80 or any other clause wherein said multi-node interlock comprises a series configured multi-node interlock.
83. An operational system for series generative AC devices as described in clause 80 or any other clause wherein said multi-node interlock comprises a string disconnect interlock system.
84. An operational system for series generative AC devices as described in clause 83 or any other clause wherein said multi-node interlock comprises an individual DC-AC inverter disconnect interlock.
85. An operational system for series generative AC devices as described in clause 69 or any other clause wherein said generative AC device control comprises a series connected DC-AC inverter modulator that is responsive to said real-time AC electrical power delivery network voltage measurement input, said real-time AC device output voltage measurement input, and said real-time AC device current measurement input.
86. An operational system for series generative AC devices as described in clause 52 or any other clause wherein said plurality of autonomous series generative AC devices are connected in a series string, wherein said generative AC device control comprises a plurality of generative AC device controls that continuously reapportion voltage among said series string.
87. An operational system for series generative AC devices as described in clause 45 or any other clause wherein said high-resolution AC electrical power delivery network voltage input comprises an AC electrical power delivery network voltage divider impedance.
88. An operational system for series generative AC devices as described in clause 45 or any other clause wherein said high-resolution AC electrical power delivery network voltage input comprises an AC electrical power delivery network voltage measurement amplifier.
89. An operational system for series generative AC devices as described in clause 45 or any other clause further comprising at least one beta synthesis element.
90. An operational system for series generative AC devices as described in clause 89 or any other clause wherein said at least one beta synthesis element comprises a delay buffer.
91. An operational system for series generative AC devices as described in clause 89 or any other clause wherein said at least one beta synthesis element comprises a gain compensated filter.
92. An operational system for series generative AC devices as described in clause 45 or any other clause and further comprising a high-resolution AC electrical power delivery network voltage phase-locked-loop input.
93. An operational system for series generative AC devices as described in clause 73 or any other clause wherein said high-resolution AC electrical power delivery network voltage feed-forward input comprises a feed-forward beta synthesis input.
94. An operational system for series generative AC devices as described in clause 73 or any other clause and further comprising at least one stationary to/from synchronous reference frame transformation element.
95. An operational system for series generative AC devices as described in clause 73 or any other clause wherein said high-resolution AC electrical power delivery network voltage input comprises at least one stationary to synchronous reference frame transformation element.
96. An operational system for series generative AC devices as described in clause 45 or any other clause further comprising a bus compensation component.
97. An operational system for series generative AC devices as described in clause 73 or any other clause wherein said high-resolution AC electrical power delivery network voltage feed-forward input comprises a feed forward bus compensation component.
98. An operational system for series generative AC devices as described in clause 97 or any other clause wherein said feed forward bus compensation component comprises a voltage gain compensator.
99. An operational system for series generative AC devices as described in clause 97 or any other clause wherein said feed forward bus compensation component comprises an externally directed adjustment gain.
100. An operational system for series generative AC devices as described in clause 70 or any other clause wherein said real-time AC device output power feedback input comprises a direct-axis current component.
101. An operational system for series generative AC devices as described in clause 73 or any other clause wherein said high-resolution AC electrical power delivery network voltage feed-forward input further comprising an integrated reference voltage gain compensator.
102. An operational system for series generative AC devices as described in clause 45 or any other clause further comprising a summing amplifier.
103. An operational system for series generative AC devices as described in clause 102 or any other clause wherein said summing amplifier comprises a feed-forward loop and feedback loop summing amplifier.
104. An operational system for series generative AC devices as described in clause 45 or any other clause wherein said generative AC device control comprises a pulse width modulation control.
105. An operational system for series generative AC devices as described in clause 70 or any other clause wherein said real-time AC device output power feedback input comprises a current feedback loop.
106. An operational system for series generative AC devices as described in clause 105 or any other clause wherein said current feedback loop comprises a real-time AC device current measurement input.
107. An operational system for series generative AC devices as described in clause 105 or any other clause wherein said current feedback loop comprises a beta synthesis element.
108. An operational system for series generative AC devices as described in clause 106 or any other clause wherein said current feedback loop further comprising a direct-axis current component.
109. An operational system for series generative AC devices as described in clause 108 or any other clause wherein said current feedback loop further comprising a quadrature-axis current component.
110. An operational system for series generative AC devices as described in clause 109 or any other clause wherein said current feedback loop further comprises: a direct-axis feedback disconnect; and a quadrature-axis feedback disconnect
111. An operational system for series generative AC devices as described in clause 110 or any other clause wherein said direct-axis feedback disconnect and said quadrature-axis feedback disconnect are both responsive to a substantially non-power producing state.
112. An operational system for series generative AC devices as described in clause 45 or any other clause wherein said real-time AC device output power data input comprises at least one feedback beta synthesis input.
113. An operational system for series generative AC devices as described in clause 45 or any other clause wherein said real-time AC device output power data input comprises at least one stationary to synchronous reference frame transformation element.
114. An operational system for series generative AC devices as described in clause 45 or any other clause wherein said real-time AC device output power data input comprises: a real power multiplier component; and a reactive power multiplier component.
115. An operational system for series generative AC devices as described in clause 114 or any other clause wherein said real-time AC device output power data input further comprises: a real power amplifier; and a reactive power amplifier.
116. An operational system for series generative AC devices comprising: at least one plurality of series generative AC devices connected as an AC generative series string having an AC generative series string output; a substantially non-power producing, plurality of series generative AC devices-operative, AC generative series string energizer; and an active AC generative series string connection element.
117. An operational system for series generative AC devices as described in clause 116 or any other clause and further comprising: an AC generative series string output sensor; an AC generative series string output evaluator responsive to said AC generative series string output sensor at times said AC generative series string is in a substantially non-power producing state; and wherein said active AC generative series string connection element is responsive to said AC generative series string output evaluator.
118. An operational system for series generative AC devices as described in clause 116 or any other clause wherein said at least one plurality of series generative AC devices comprises at least one plurality of series connected DC-AC inverters.
119. An operational system for series generative AC devices as described in clause 117 or any other clause wherein said AC generative series string output evaluator further comprising an individual series generative AC device condition output evaluator.
120. An operational system for series generative AC devices as described in clause 116 or any other clause further comprising: a plurality of individual series generative AC device-associated divider impedances; and a high-resolution AC electrical power delivery network voltage input.
121. An operational system for series generative AC devices as described in clause 120 or any other clause wherein said high-resolution AC electrical power delivery network voltage input comprises a series connected line between each of said at least one plurality of series generative AC devices connected as an AC generative series string having an AC generative series string output.
122. An operational system for series generative AC devices as described in clause 116 or any other clause wherein said substantially non-power producing state comprises a substantially full system voltage and insubstantial current state.
123. An operational system for series generative AC devices as described in clause 117 or any other clause wherein said AC generative series string output evaluator is configured to operate when there is insubstantial current for said at least one plurality of series generative AC devices.
124. An operational system for series generative AC devices as described in clause 116 or any other clause wherein said at least one plurality of series generative AC devices connected as an AC generative series string having an AC generative series string output is selected from: at least one single phase plurality of series generative AC devices connected as an AC generative series string having an AC generative series string output; and at least one poly phase plurality of series generative AC devices connected as a poly phase AC generative series string having a poly phase plurality of AC generative series string outputs.
125. An operational system for series generative AC devices as described in clause 120 or any other clause wherein said high-resolution AC electrical power delivery network voltage input comprises a current-limited high-resolution AC electrical power delivery network voltage input.
126. An operational system for series generative AC devices as described in clause 116 or any other clause and further comprising at least one plurality of generative AC device controls, each to which one of said plurality of series generative AC devices is individually responsive, and wherein each of said at least one plurality of generative AC device controls comprises: a feedback element; and a feedback element disconnect.
127. An operational system for series generative AC devices as described in clause 126 or any other clause wherein said feedback element disconnect is operative when said AC generative series string output evaluator is active.
128. An operational system for series generative AC devices as described in clause 116 or any other clause wherein each of said at least one plurality of series generative AC devices has a power input, and wherein said substantially non-power producing, plurality of series generative AC devices-operative, AC generative series string energizer is independent of any of said power inputs.
129. An operational system for series generative AC devices as described in clause 128 or any other clause wherein said substantially non-power producing, plurality of series generative AC devices-operative, AC generative series string energizer comprises an AC electrical power delivery network voltage.
130. An operational system for series generative AC devices as described in clause 128 or any other clause wherein said substantially non-power producing, plurality of series generative AC devices-operative, AC generative series string energizer comprises a high-resolution AC electrical power delivery network voltage input.
131. An operational system for series generative AC devices as described in clause 116 or any other clause wherein said substantially non-power producing, plurality of series generative AC devices-operative, AC generative series string energizer is independent of said AC generative series string output.
132. An operational system for series generative AC devices as described in clause 130 or any other clause and further comprising a series generative AC device-operative voltage divider configured to provide sufficient power in said high-resolution AC electrical power delivery network voltage input to minimally achieve substantially non-power producing series generative AC device full operation.
133. An operational system for series generative AC devices as described in clause 116 or any other clause further comprising a decisionally-controlled AC string connection element.
134. An operational system for series generative AC devices as described in clause 133 or any other clause and further comprising a high-resolution AC electrical power delivery network voltage input, and wherein said decisionally-controlled AC string connection element is responsive to a reference line common-mode current.
135. An operational system for series generative AC devices as described in clause 133 or any other clause wherein said decisionally-controlled AC string connection element is decisionally responsive to one or more set permissible limits.
136. An operational system for series generative AC devices as described in clause 120 or any other clause wherein said high-resolution AC electrical power delivery network voltage input further comprises a series-connectable, device control feed-forward input.
137. An operational system for series generative AC devices comprising: a series generative AC device having a generative AC output; at least one AC output-parametric electrical effect impacting said generative AC output; and a controllable, intermittently operative, AC output-parametric electrical effect reduction system configured to operate at selected times.
138. An operational system for series generative AC devices as described in clause 137 or any other clause wherein said at least one AC output-parametric electrical effect comprises at least part of an admittance of said generative AC output.
139. An operational system for series generative AC devices as described in clause 138 or any other clause wherein said admittance comprises series generative AC device, generative AC output parallel admittance.
140. An operational system for series generative AC devices as described in clause 139 or any other clause wherein said controllable, intermittently operative, AC output-parametric electrical effect reduction system comprises a component severance switch.
141. An operational system for series generative AC devices as described in clause 137 or any other clause wherein said at least one AC output-parametric electrical effect comprises at least part of a filter for said generative AC output.
142. An operational system for series generative AC devices as described in clause 141 or any other clause wherein said controllable, intermittently operative, AC output-parametric electrical effect reduction system comprises a series generative AC device, generative AC output parallel, filter element switch.
143. An operational system for series generative AC devices as described in clause 142 or any other clause wherein said series generative AC device, generative AC output parallel, filter element switch comprises at least one generative AC output parallel capacitor filter element switch.
144. An operational system for series generative AC devices as described in clause 137 or any other clause wherein said series generative AC device comprises a series connected DC-AC inverter.
145. An operational system for series generative AC devices as described in clause 137 or any other clause further comprising a high-resolution AC electrical power delivery network voltage input.
146. An operational system for series generative AC devices as described in clause 145 or any other clause wherein said high-resolution AC electrical power delivery network voltage input comprises at least one series voltage divider configured input.
147. An operational system for series generative AC devices as described in clause 146 or any other clause wherein said at least one series voltage divider configured input has a first series connection, a second series connection, and a voltage divider output, and wherein said at least one series voltage divider configured input is selected from: a voltage divider impedance pair from said first series connection to an internal reference point; a voltage divider impedance pair from a second series connection to an internal reference point; and both a voltage divider impedance pair from said first series connection to an internal reference point and a voltage divider impedance pair from a second series connection to an internal reference point.
148. An operational system for series generative AC devices as described in clause 147 or any other clause wherein said voltage divider output comprises a measurement amplifier input.
149. An operational system for series generative AC devices as described in clause 137 or any other clause wherein said at least one AC output-parametric electrical effect comprises a conductance to remote ground.
150. An operational system for series generative AC devices as described in clause 137 or any other clause wherein said at least one AC output-parametric electrical effect comprises a capacitive susceptance to remote ground.
151. An operational system for series generative AC devices as described in clause 137 or any other clause wherein said selected times at which said controllable, intermittently operative, AC output-parametric electrical effect reduction system operates comprises at least some times when an AC generative series string is in a substantially non-power producing state.
152. An operational system for series generative AC devices as described in clause 137 or any other clause wherein said selected times at which said controllable, intermittently operative, AC output-parametric electrical effect reduction system operates comprises a series generative AC device startup time.
153. An operational system for series generative AC devices comprising: at least one series generative AC device having an operational power input; a first series generative AC device operational power source; a second series generative AC device operational power source; and an operational power source transition system configured to alterably provide operational power to said at least one series generative AC device at times from said first series generative AC device operational power source and at other times from said second series generative AC device operational power source.
154. An operational system for series generative AC devices as described in clause 153 or any other clause wherein said operational power source transition system comprises a tiered series generative AC device operational power source voltage configuration.
155. An operational system for series generative AC devices as described in clause 153 or any other clause wherein said operational power source transition system comprises an operational power source transition switch system.
156. An operational system for series generative AC devices as described in clause 153 or any other clause wherein said operational power source transition system is configured to facilitate uninterrupted AC device operation at a functional level.
157. An operational system for series generative AC devices as described in clause 153 or any other clause wherein said first series generative AC device operational power source comprises a substantially non-power producing, AC generative device energizer.
158. An operational system for series generative AC devices as described in clause 153 or any other clause wherein said first series generative AC device operational power source comprises a substantially non-power producing series generative AC device-operative, AC generative device energizer.
159. An operational system for series generative AC devices as described in clause 153 or any other clause wherein said first series generative AC device operational power source is selected from: an AC electrical power delivery network voltage input, a DC input to said series generative AC device, a post individual source total DC input power disconnect DC input to said series generative AC device, a series generative AC device output, and grid power.
160. An operational system for series generative AC devices as described in clause 153 or any other clause and further comprising: an AC generative series string output sensor; and an AC generative series string output evaluator responsive to said AC generative series string output sensor at times said AC generative series string is in a substantially non-power producing state.
161. An operational system for series generative AC devices as described in clause 153 or any other clause and further comprising a series generative AC device connection element coordinated with said operational power source transition system.
162. An operational system for series generative AC devices as described in clause 161 or any other clause wherein said series generative AC device connection element comprises an individual series generative AC device connection element.
163. An operational system for series generative AC devices as described in clause 161 or any other clause wherein said series generative AC device connection element comprises an active AC generative series string connection element.
164. An operational system for series generative AC devices as described in clause 161 or any other clause wherein said series generative AC device connection element comprises a system connection device.
165. An operational system for series generative AC devices comprising: a plurality of DC input power sources, each having a DC output; a plurality of AC power generation systems, each AC power generation system configured to accept one of said DC outputs as an AC power generation system input; a plurality of individual source total DC input power disconnects, each configured prior a respective AC power generation system, and each said individual source total DC input power disconnect having no AC power generation system utilizable power output prior to each said individual source total DC input power disconnect; and an AC voltage output through which power from said plurality of AC power generation systems is supplied.
166. An operational system for series generative AC devices comprising: a plurality of DC input power sources, each having a DC output; a plurality of series AC power generation systems, each series AC power generation system configured to accept one of said DC outputs as a series AC power generation system input; a plurality of individual source total DC input power disconnects, each configured prior a respective series AC power generation system, and each said individual source total DC input power disconnect having no AC power generation system utilizable power output prior to each said individual source total DC input power disconnect; and an AC voltage output through which power from said plurality of series AC power generation systems is supplied.
167. An operational system for generative AC devices as described in clause 165 or any other clause wherein each of said plurality of AC power generation systems comprises a DC-DC converter.
168. An operational system for generative AC devices as described in clause 167 or any other clause wherein each of said plurality of AC power generation systems further comprises a DC-AC inverter.
169. An operational system for generative AC devices as described in clause 166 or any other clause wherein each of said plurality of AC power generation systems comprises a DC-DC converter.
170. An operational system for generative AC devices as described in clause 169 or any other clause wherein each of said plurality of AC power generation systems further comprises a DC-AC inverter.
171. An operational system for generative AC devices as described in clause 168 or any other clause and further comprising a plurality of post-individual source total DC input power disconnect, generative AC device operational power sources, each connected to a respective DC output after a respective individual source total DC input power disconnect.
172. An operational system for generative AC devices as described in clause 166 or any other clause wherein said plurality of post-individual source total DC input power disconnect, generative AC device operational power sources comprises a global total DC input power disconnect.
173. An operational system for series generative AC devices comprising: a plurality of autonomously self-controlled, series generative AC devices having an operational power input and a generative AC output; a series configured connection system through which said plurality of autonomously self-controlled, series generative AC devices are connected in a string having an AC generative series string output; a plurality of individual generative AC device respective real-time AC device output power data inputs; a plurality of individual generative AC device respective high-resolution AC electrical power delivery network voltage data inputs; a plurality of individual generative AC device respective generative AC device controls, each responsive to an individual generative AC device respective real-time AC device output power data input and an individual generative AC device respective high-resolution AC electrical power delivery network voltage data input, and wherein said plurality of autonomously self-controlled, series generative AC devices responsive are responsive to an individual generative AC device respective generative AC device control; a plurality of individual generative AC device respective, substantially non-power producing, individual autonomously self-controlled, series generative AC device-operative, AC generative series string energizers; a plurality of individual generative AC device respective power producing series generative AC device operational power sources; a plurality of individual generative AC device respective operational power source transition systems configured to alterably provide operational power to a respective individual autonomously self-controlled, series generative AC device at times from an individual generative AC device respective substantially non-power producing, autonomously self-controlled, series generative AC device-operative, AC generative series string energizer and at other times from an individual generative AC device respective power producing series generative AC device operational power source; a plurality of individual generative AC device respective controllable, intermittently operative, AC output-parametric electrical effect reduction systems configured to operate at selected times; and a series-additive composite AC voltage output through which power from said plurality of autonomously self-controlled, series generative AC devices is supplied.
174. An operational system for series generative AC devices as described in clause 173 or any other clause wherein said plurality of autonomously self-controlled, series generative AC devices comprises a plurality of non-centrally directed control series generative AC devices.
175. An operational system for series generative AC devices as described in clause 174 or any other clause wherein said plurality of autonomously self-controlled, series generative AC devices comprises a plurality of autonomously self-controlled, heterogenous AC output voltage, series generative AC devices that sum to an AC electrical power delivery network voltage.
176. An operational system for series generative AC devices as described in clause 175 or any other clause and further comprising a communications line configured to effect control of at least some activity of said plurality of autonomously self-controlled, series generative AC devices.
177. An operational system for series generative AC devices as described in clause 176 or any other clause wherein said communications line comprises a serially connected communications line connected to each of said plurality of autonomously self-controlled, series generative AC devices.
178. An operational system for series generative AC devices as described in clause 177 or any other clause and further comprising a communications line configured to effect control of at least some activity of a plurality of series generative AC devices, and wherein said communications line, said series-additive composite AC voltage output, and said plurality of individual generative AC device respective high-resolution AC electrical power delivery network voltage data inputs, are contained within the same cable.
179. An operational system for series generative AC devices as described in clause 175 or any other clause and further comprising a feed-forward loop and feedback loop summing amplifier.
180. An operational system for series generative AC devices comprising: a plurality of autonomously self-controlled, series generative AC devices; a series configured connection system through which said plurality of autonomously self-controlled, series generative AC devices are connected in a string having an AC generative series string output; a plurality of individual generative AC device respective real-time AC device output power data inputs; a plurality of individual generative AC device respective high-resolution AC electrical power delivery network voltage data inputs; a plurality of individual generative AC device respective generative AC device controls, each responsive to an individual generative AC device respective real-time AC device output power data input and an individual generative AC device respective high-resolution AC electrical power delivery network voltage data input, and wherein said plurality of autonomously self-controlled, series generative AC devices are each responsive to an individual generative AC device respective generative AC device control; and a series-additive composite AC voltage output through which power from said plurality of autonomously self-controlled, series generative AC devices is supplied.
181. An operational system for series generative AC devices as described in clause 180 or any other clause wherein said plurality of individual generative AC device respective high-resolution AC electrical power delivery network voltage data inputs comprises a plurality of analog AC electrical power delivery network voltage inputs.
182. An operational system for series generative AC devices as described in clause 180 or any other clause wherein said series-additive composite AC voltage output and said plurality of individual generative AC device respective high-resolution AC electrical power delivery network voltage data inputs are contained within the same cable.
183. An operational system for series generative AC devices as described in clause 180 or any other clause wherein said plurality of individual generative AC device respective high-resolution AC electrical power delivery network voltage data inputs comprises a series voltage divider configured input.
184. An operational system for series generative AC devices as described in clause 183 or any other clause wherein said series voltage divider configured input comprises a plurality of individual series generative AC device-associated divider impedances.
185. An operational system for series generative AC devices as described in clause 180 or any other clause wherein said AC generative series string output comprises a plurality of AC generative series string outputs that sum to an AC electrical power delivery network voltage.
186. An operational system for series generative AC devices as described in clause 180 or any other clause wherein each of said plurality of individual generative AC device respective high-resolution AC electrical power delivery network voltage data inputs comprise an AC electrical power delivery network voltage input that accurately represents the AC electrical power delivery network voltage at greater than two accurate points of voltage information per AC cycle.
187. An operational system for series generative AC devices as described in clause 180 or any other clause wherein each of said plurality of individual generative AC device respective high-resolution AC electrical power delivery network voltage data inputs is selected from: an AC electrical power delivery network voltage input that accurately represents the AC electrical power delivery network voltage at greater than 15 accurate points of voltage information per AC cycle; an AC electrical power delivery network voltage input that accurately represents the AC electrical power delivery network voltage at greater than 30 accurate points of voltage information per AC cycle; an AC electrical power delivery network voltage input that accurately represents the AC electrical power delivery network voltage at greater than 100 accurate points of voltage information per AC cycle; an AC electrical power delivery network voltage input that accurately represents the AC electrical power delivery network voltage at greater than 166 accurate points of voltage information per AC cycle; a substantially continuous AC electrical power delivery network voltage input; and an analog input.
188. An operational system for series generative AC devices as described in clause 180 or any other clause wherein each of said plurality of individual generative AC device respective high-resolution AC electrical power delivery network voltage data inputs comprises an actual, dynamic delivery network voltage waveform.
189. An operational system for series generative AC devices as described in clause 180 or any other clause wherein said plurality of individual generative AC device respective generative AC device controls each comprise a substantially instantaneous generative AC device waveform control.
190. An operational system for series generative AC devices as described in clause 188 or any other clause wherein said substantially instantaneous generative AC device waveform control comprises a substantially instantaneous, dynamic, delivery network waveform mimicking control.
191. An operational system for series generative AC devices as described in clause 180 or any other clause wherein said plurality of individual generative AC device respective high-resolution AC electrical power delivery network voltage data inputs comprises a real-time AC electrical power delivery network voltage measurement input.
192. An operational system for series generative AC devices as described in clause 191 or any other clause and further comprising: a real-time AC electrical power delivery network voltage measurement input; a plurality of respective real-time AC device output voltage measurement inputs; and at least one real-time AC device current measurement input.
193. An operational system for series generative AC devices as described in clause 192 or any other clause wherein said real-time AC electrical power delivery network voltage measurement input comprises a real-time AC device output power feedback input.
194. An operational system for series generative AC devices as described in clause 180 or any other clause wherein said plurality of individual generative AC device respective high-resolution AC electrical power delivery network voltage data inputs comprises a plurality of high-resolution AC electrical power delivery network voltage feed-forward inputs.
195. An operational system for series generative AC devices as described in clause 192 or any other clause wherein said plurality of individual generative AC device respective generative AC device controls comprises a plurality of series connected DC-AC inverter modulators that are responsive to a respective real-time AC electrical power delivery network voltage measurement input, a respective real-time AC device output voltage measurement input, and a respective real-time AC device current measurement input.
196. An operational system for series generative AC devices as described in clause 180 or any other clause wherein said plurality of individual generative AC device respective generative AC device controls comprises a plurality of generative AC device controls that continuously reapportion voltage among said series string.
197. An operational system for series generative AC devices as described in clause 180 or any other clause further comprising at least one beta synthesis element.
198. An operational system for series generative AC devices as described in clause 194 or any other clause wherein said high-resolution AC electrical power delivery network voltage feed-forward input comprises a feed-forward beta synthesis input.
199. An operational system for series generative AC devices as described in clause 194 or any other clause and further comprising at least one stationary to/from synchronous reference frame transformation element.
200. An operational system for series generative AC devices as described in clause 194 or any other clause wherein said high-resolution AC electrical power delivery network voltage feed-forward input comprises a feed forward bus compensation component.
201. An operational system for series generative AC devices as described in clause 193 or any other clause wherein said real-time AC device output power feedback input comprises a current feedback loop.
202. An operational system for series generative AC devices as described in clause 193 or any other clause wherein said feedback disconnect is responsive to a substantially non-power producing state.
203. An operational system for series generative AC devices as described in clause 180 or any other clause wherein said real-time AC device output power data input comprises at least one feedback beta synthesis input.
204. An operational system for series generative AC devices as described in clause 180 or any other clause wherein said real-time AC device output power data input comprises: a real power multiplier component; and a reactive power multiplier component.
205. An operational system for series generative AC devices comprising: a plurality of series generative AC devices, each having an operational power input; a plurality of individual generative AC device respective, substantially non-power producing series generative AC device-operative, AC generative device energizers; a plurality of individual generative AC device respective, second series generative AC device operational power sources; and an operational power source transition system configured to alterably provide operational power to each of said generative AC devices at times from one of said individual generative AC device respective, substantially non-power producing series generative AC device-operative, AC generative device energizers and at other times from one of said second series generative AC device operational power sources; and an active AC generative series string connection element.
206. An operational system for series generative AC devices as described in clause 205 or any other clause wherein said operational power source transition system comprises a tiered series generative AC device operational power source voltage configuration.
207. An operational system for series generative AC devices as described in clause 205 or any other clause wherein said operational power source transition system comprises an operational power source transition switch system.
208. An operational system for series generative AC devices as described in clause 205 or any other clause wherein said plurality of individual generative AC device respective, substantially non-power producing series generative AC device-operative, AC generative device energizers are each selected from: an AC electrical power delivery network voltage input, a DC input to said series generative AC device, a post individual source total DC input power disconnect DC input to said series generative AC device, a series generative AC device output, and grid power.
209. An operational system for series generative AC devices as described in clause 205 or any other clause and further comprising a series generative AC device connection element coordinated with said operational power source transition system.
210. An operational system for series generative AC devices as described in clause 209 or any other clause wherein said series generative AC device connection element comprises a plurality of an individual series generative AC device connection elements.
211. An operational system for series generative AC devices as described in clause 209 or any other clause wherein said plurality of series generative AC device connection elements comprises a plurality of active AC generative series string connection elements.
212. An operational system for series generative AC devices as described in clause 209 or any other clause and further comprising a system connection device.
213. An operational system for series generative AC devices as described in clause 205 or any other clause wherein said plurality of individual generative AC device respective, substantially non-power producing series generative AC device-operative, AC generative device energizers is active during a substantially full system voltage and insubstantial current state.
214. An operational system for series generative AC devices as described in clause 205 or any other clause and further comprising at least one plurality of generative AC device controls, each comprising: a feedback element; and a feedback element disconnect.
215. An operational system for series generative AC devices as described in clause 205 or any other clause wherein each of said plurality of series generative AC devices has a power input, wherein said plurality of individual generative AC device respective, substantially non-power producing series generative AC device-operative, AC generative device energizers each comprise a high-resolution AC electrical power delivery network voltage input, wherein each of said plurality of individual generative AC device respective, substantially non-power producing series generative AC device-operative, AC generative device energizers are configured to provide sufficient power in said high-resolution AC electrical power delivery network voltage input to minimally achieve substantially non-power producing series generative AC device full operation, and wherein said plurality of individual generative AC device respective, substantially non-power producing series generative AC device-operative, AC generative device energizers is each independent of any of said power inputs.
216. An operational system for series generative AC devices comprising: a series generative AC device having a generative AC output; at least one AC output-parametric electrical effect impacting said generative AC output; and a controllable, intermittently operative, AC output-parametric electrical effect reduction system configured to operate at selected times.
217. An operational system for series generative AC devices as described in clause 216 or any other clause wherein said at least one AC output-parametric electrical effect comprises at least part of an admittance of said generative AC output.
218. An operational system for series generative AC devices as described in clause 217 or any other clause wherein said admittance comprises series generative AC device, generative AC output parallel admittance.
219. An operational system for series generative AC devices as described in clause 218 or any other clause wherein said controllable, intermittently operative, AC output-parametric electrical effect reduction system comprises a component severance switch.
220. An operational system for series generative AC devices as described in clause 216 or any other clause wherein said at least one AC output-parametric electrical effect comprises at least part of a filter for said generative AC output.
221. An operational system for series generative AC devices as described in clause 220 or any other clause wherein said controllable, intermittently operative, AC output-parametric electrical effect reduction system comprises a series generative AC device, generative AC output parallel, filter element switch.
222. An operational system for series generative AC devices as described in clause 221 or any other clause wherein said series generative AC device, generative AC output parallel, filter element switch comprises at least one generative AC output parallel capacitor filter element switch.
223. An operational system for series generative AC devices as described in clause 216 or any other clause wherein said selected times at which said controllable, intermittently operative, AC output-parametric electrical effect reduction system operates comprises at least some times when an AC generative series string is in a substantially non-power producing state.
224. An operational system for series generative AC devices as described in clause 216 or any other clause wherein said selected times at which said controllable, intermittently operative, AC output-parametric electrical effect reduction system operates comprises a series generative AC device startup time.
225. An operational system for generative AC devices comprising: a plurality of DC input power sources, each having a DC output; a plurality of AC power generation systems, each comprising a DC-DC converter and a DC-AC inverter, and each AC power generation system configured to accept one of said DC outputs as an AC power generation system input; a plurality of individual source total DC input power disconnects, each configured prior a respective AC power generation system, and each said individual source total DC input power disconnect having no AC power generation system utilizable power output prior to each said individual source total DC input power disconnect; and an AC voltage output through which power from said plurality of AC power generation systems is supplied.
226. An operational system for generative AC devices as described in clause 225 or any other clause and further comprising a plurality of post-individual source total DC input power disconnect, generative AC device operational power sources, each connected to a respective DC output after a respective individual source total DC input power disconnect.
227. An operational system for generative AC devices as described in clause 226 or any other clause wherein said plurality of post-individual source total DC input power disconnect, generative AC device operational power sources comprises a global total DC input power disconnect.
228. A method of operating series generative AC devices comprising the steps of: establishing at least one plurality of series generative AC devices connected as an AC generative series string to provide an AC generative series string output; energizing said plurality of series generative AC devices to a fully operative, but substantially non-power producing state; creating a substantially non-power producing AC output voltage for each of said plurality of series generative AC devices as a result of said step of energizing said plurality of series generative AC devices; and operating an active AC generative series string connection element to connect said AC generative series string output.
229. A method of operating series generative AC devices comprising the steps of: establishing at least one plurality of series generative AC devices connected as an AC generative series string to provide an AC generative series string output; energizing operation of said plurality of series generative AC devices; creating a substantially non-power producing AC output voltage for each of said plurality of series generative AC devices by operation of each of said plurality of series generative AC devices; sensing said AC generative series string output when said AC generative series string is in a substantially non-power producing state; evaluating a voltage of said AC generative series string output; and operating an active AC generative series string connection element in response to said step of evaluating a voltage of said AC generative series string output.
230. A method of operating series generative AC devices as described in clause 228 or any other clause and further comprising the step of providing information regarding an AC electrical power delivery network voltage.
231. A method of operating series generative AC devices as described in clause 229 or any other clause and further comprising the step of providing information regarding an AC electrical power delivery network voltage.
232. A method of operating series generative AC devices as described in clause 231 or any other clause wherein said step of evaluating a voltage of said AC generative series string output comprises the step of evaluating if said voltage of said AC generative series string output matches said AC electrical power delivery network voltage.
233. A method of operating series generative AC devices as described in clause 230 or any other clause wherein said providing AC system voltage information comprises issuing a reference signal on a line separate from the power output.
234. A method of operating series generative AC devices as described in clause 228 or any other clause wherein said step of operating an active AC generative series string connection element in response to said step of evaluating a voltage of said AC generative series string output comprises the step of confirming that an interlock is satisfied.
235. A method of operating series generative AC devices as described in clause 231 or any other clause wherein said step of evaluating if said voltage of said AC generative series string output matches said AC electrical power delivery network voltage comprises the step of checking for the proper operation of each generative device.
236. A method of operating series generative AC devices as described in clause 231 or any other clause and further comprising the step of operating a system connection device.

As can be easily understood from the foregoing, the basic concepts of the various embodiments of the present invention(s) may be embodied in a variety of ways. It involves both inverter combination techniques as well as devices to accomplish the appropriate inverter or AC combination to provide power In this application, the combination techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the various embodiments of the invention(s) and may not explicitly show how each feature or element can actually be representative of a broader function or of a great variety of alternative or equivalent elements. As one example, terms of degree, terms of approximation, and/or relative terms may be used. These may include terms such as the words: substantially, about, only, and the like. These words and types of words are to be understood in a dictionary sense as terms that encompass an ample or considerable amount, quantity, size, etc. as well as terms that encompass largely but not wholly that which is specified. Further, for this application if or when used, terms of degree, terms of approximation, and/or relative terms should be understood as also encompassing more precise and even quantitative values that include various levels of precision and the possibility of claims that address a number of quantitative options and alternatives. In context, these should be understood by a person of ordinary skill as being disclosed and included whether in an absolute value sense or in valuing one set of or substance as compared to the value of a second set of or substance. Again, these are implicitly included in this disclosure and should (and, it is believed, would) be understood to a person of ordinary skill in this field. Where the application is described in device-oriented terminology, each element of the device implicitly performs a function. Apparatus claims may not only be included for the device described, but also method or process claims may be included to address the functions of the embodiments and that each element performs. Neither the description nor the terminology is intended to limit the scope of the claims that will be included in any subsequent patent application.

It should also be understood that a variety of changes may be made without departing from the essence of the various embodiments of the invention(s). Such changes are also implicitly included in the description. They still fall within the scope of the various embodiments of the invention(s). A broad disclosure encompassing the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of embodiments of the invention(s) both independently and as an overall system.

Further, each of the various elements of the embodiments of the invention(s) and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the various embodiments of the invention(s), the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which embodiments of the invention(s) is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “control” should be understood to encompass disclosure of the act of “controlling”—whether explicitly discussed or not—and, conversely, were there effectively disclosure of the act of “controlling”, such a disclosure should be understood to encompass disclosure of a “control” and even a “means for controlling.” Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function. As other non-limiting examples, it should be understood that claim elements can also be expressed as any of: components, programming, subroutines, logic, or elements that are configured to, or configured and arranged to, provide or even achieve a particular result, use, purpose, situation, function, or operation, or as components that are capable of achieving a particular activity, result, use, purpose, situation, function, or operation. All should be understood as within the scope of this disclosure and written description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed below or other information statement filed with the application are hereby appended and hereby incorporated by reference, however, as to each of the above, to the extent that such information or statements incorporated by reference might be considered inconsistent with the patenting of the various embodiments of invention(s) such statements are expressly not to be considered as made by the applicant(s).

U.S. PATENTS

| | | | Name of Patentee |
|---|---|---|---|
| | Kind | | or Applicant |
| Patent Number | Code¹ | Issue Date | of cited Document |
| 9,419,438 | B2 | 2016 Aug. 16 | Pruett et al. |
| 9,531,293 | | 2016 Dec. 27 | Bhowmik |
| 9,866,098 | | 2018 Jan. 9 | Yoscovich et al. |
| 10,439,513 | | 2019 Oct. 8 | Cox et al. |
| 10,998,833 | | 2021 May 4 | Ilic et al. |

U.S. PATENT APPLICATION PUBLICATIONS

| | | | | Name of Patentee |
|---|---|---|---|---|
| | Publication | Kind | Publication | or Applicant |
| Cite No | Number | Code¹ | Date | of cited Document |
| 3 | 20120001817 | A1 | 2012 Apr. 19 | Seymour et al. |
| 2 | 20118812438 | A1 | 2021 Jan. 20 | Cheng et al. |

Thus, the applicant(s) should be understood to have support to claim and make claims to embodiments including at least: i) each of the power devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such processes, methods, systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrases “comprising”, “including”, “containing”, “characterized by” and “having” are used to maintain the “open-end” claims herein, according to traditional claim interpretation including that discussed in MPEP § 2111.03. Thus, unless the context requires otherwise, it should be understood that the terms “comprise” or variations such as “comprises” or “comprising”, “include” or variations such as “includes” or “including”, “contain” or variations such as “contains” and “containing”, “characterized by” or variations such as “characterizing by”, “have” or variations such as “has” or “having”, are intended to imply the inclusion of a stated element or step or group of elements or steps but not the exclusion of any other element or step or group of elements or steps. Such terms should be interpreted in their most expansive form so as to afford the applicant the broadest coverage legally permissible. It should be understood that the term “a” used in the description and claims could mean “one” or could mean “at least one.” Use of “at least one” in the description and claims is not intended nor used in this disclosure to mean that other claims or descriptions not incorporating the “at least one” language cannot further include one or more like elements and the language “at least one” is not intended nor used to change “open-ended” claims, inherently including devices or methods having additional elements or steps apart from those claimed, into “closed-ended” claims wherein devices or methods having additional elements would not be covered by such claims. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 9 or any other claim” or the like, it could be re-drafted as dependent on claim 1, claim 8, or even claim 11 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

With respect to the drawings, it should be understood that these present only initial views, mirror views such as left, right, top, bottom, front, and back should be understood as within the realm of this disclosure as may be appropriate for design or industrial design protections. Furthermore, any aspect and any portion of such drawings should be understood as potentially not within the scope of any then-made claim such as by then dashing any portion desired. And such drawings should be understood as including drawing elements such as rectangles, circles, ellipses, ovals, squares, and the like as particular side or other views as well understood from the existing drawings.

Also, with respect to design patent drawings, break in a line accompanied by a wavy line perpendicular to the broken line should be used to depict lines of varying length. The benefit of this is to claim the material regardless of varying length. Dashed lines can be used to disclaim parts of the design.

Finally, any claims set forth at any time are hereby incorporated by reference as part of this description of the various embodiments of the application, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. An operational system for series generative AC devices comprising:
a plurality of autonomously self-controlled, series generative AC devices having an operational power input and a generative AC output;
a series configured connection system through which said plurality of autonomously self-controlled, series generative AC devices are connected in a string having an AC generative series string output;
a plurality of individual generative AC device respective real-time AC device output power data inputs;
a plurality of individual generative AC device respective substantially accurate high-resolution AC electrical power delivery network voltage data inputs;
a plurality of individual generative AC device respective generative AC device controls, each responsive to an individual generative AC device respective real-time AC device output power data input and an individual generative AC device respective substantially accurate high-resolution AC electrical power delivery network voltage data input, and wherein said plurality of autonomously self-controlled, series generative AC devices responsive are responsive to an individual generative AC device respective generative AC device control;
a plurality of individual generative AC device respective, substantially non-power producing, individual autonomously self-controlled, series generative AC device-operative, AC generative series string energizers;
a plurality of individual generative AC device respective power producing series generative AC device operational power sources;
a plurality of individual generative AC device respective operational power source transition systems configured to alterably provide operational power to a respective individual autonomously self-controlled, series generative AC device at times from an individual generative AC device respective substantially non-power producing, autonomously self-controlled, series generative AC device-operative, AC generative series string energizer and at other times from an individual generative AC device respective power producing series generative AC device operational power source;
a plurality of individual generative AC device respective controllable, intermittently operative, AC output-parametric electrical effect reduction systems configured to operate at selected times for each of the generated outputs; and
a series-additive composite AC voltage output through which power from said plurality of autonomously self-controlled, series generative AC devices is supplied.

2. An operational system for series generative AC devices as described in claim 1 wherein said plurality of autonomously self-controlled, series generative AC devices comprises a plurality of non-centrally directed control series generative AC devices.

3. An operational system for series generative AC devices as described in claim 2 wherein said plurality of autonomously self-controlled, series generative AC devices comprises a plurality of autonomously self-controlled, heterogenous AC output voltage, series generative AC devices that sum to an AC electrical power delivery network voltage.

4. An operational system for series generative AC devices as described in claim 3 and further comprising a communications line configured to effect control of at least some activity of said plurality of autonomously self-controlled, series generative AC devices.

5. An operational system for series generative AC devices as described in claim 4 wherein said communications line comprises a serially connected communications line connected to each of said plurality of autonomously self-controlled, series generative AC devices.

6. An operational system for series generative AC devices as described in claim 5 and further comprising a communications line configured to effect control of at least some activity of a plurality of series generative AC devices, and wherein said communications line, said series-additive composite AC voltage output, and said plurality of individual generative AC device respective substantially accurate high-resolution AC electrical power delivery network voltage data inputs, are contained within the same cable.

7. An operational system for series generative AC devices as described in claim 3 and further comprising a feed-forward loop and feedback loop summing amplifier.

8-43. (canceled)

44. An operational system for series generative AC devices comprising:
a series generative AC device having a generative AC output;
at least one AC output-parametric electrical effect impacting said generative AC output; and
a controllable, intermittently operative, AC output-parametric electrical effect reduction system configured to operate at selected times for each of the generated outputs.

45. An operational system for series generative AC devices as described in claim 44 wherein said at least one AC output-parametric electrical effect comprises at least part of an admittance of said generative AC output.

46. An operational system for series generative AC devices as described in claim 45 wherein said admittance comprises series generative AC device, generative AC output parallel admittance.

47. An operational system for series generative AC devices as described in claim 46 wherein said controllable, intermittently operative, AC output-parametric electrical effect reduction system comprises a component severance switch.

48. An operational system for series generative AC devices as described in claim 44 wherein said at least one AC output-parametric electrical effect comprises at least part of a filter for said generative AC output.

49. An operational system for series generative AC devices as described in claim 49 wherein said controllable, intermittently operative, AC output-parametric electrical effect reduction system comprises a series generative AC device, generative AC output parallel, filter element switch.

50-55. (canceled)

56. An operational system for series generative AC devices comprising: a real-time AC device output power data input; a high-resolution AC electrical power delivery network voltage input; and a generative AC device control responsive to both said real-time AC device output power data input and said high-resolution AC electrical power delivery network voltage data input.

57. An operational system for series generative AC devices as described in claim 56 wherein said high-resolution AC electrical power delivery network voltage input is selected from: a non-pure sine AC electrical power delivery network voltage input; a non-derived AC electrical power delivery network voltage input; and a non-presumed AC electrical power delivery network voltage input.

58. An operational system for series generative AC devices as described in claim 56 wherein said high-resolution AC electrical power delivery network voltage input comprises an AC electrical power delivery network voltage input that accurately represents the AC electrical power delivery network voltage at greater than two accurate points of voltage information per AC cycle.

59. An operational system for series generative AC devices as described in claim 56 wherein said high-resolution AC electrical power delivery network voltage input is selected from: an AC electrical power delivery network voltage input that accurately represents the AC electrical power delivery network voltage at greater than 15 accurate points of voltage information per AC cycle; an AC electrical power delivery network voltage input that accurately represents the AC electrical power delivery network voltage at greater than 30 accurate points of voltage information per AC cycle; an AC electrical power delivery network voltage input that accurately represents the AC electrical power delivery network voltage at greater than 100 accurate points of voltage information per AC cycle; an AC electrical power delivery network voltage input that accurately represents the AC electrical power delivery network voltage at greater than 166 accurate points of voltage information per AC cycle; a substantially continuous AC electrical power delivery network voltage input; and an analog input.

60. An operational system for series generative AC devices as described in claim 56 wherein said high-resolution AC electrical power delivery network voltage input comprises an analog AC electrical power delivery network voltage input that is relative to the precise AC electrical power delivery network voltage.

61. An operational system for series generative AC devices as described in claim 56 wherein said high-resolution AC electrical power delivery network voltage input comprises an actual, dynamic delivery network voltage waveform.

62. An operational system for series generative AC devices as described in claim 56 wherein said generative AC device control comprises a generative AC device waveform mimicking control; wherein said generative AC device waveform mimicking control comprises a full cycle generative AC device control; and wherein said full cycle generative AC device control comprises a substantially instantaneous generative AC device waveform control.
